(19) United States
(12) Patent Application Publication
(10) Pub. No.: US 2015/0168796 A1
(43) Pub. Date: Jun. 18, 2015

(54) ELECTROCHROMIC DEVICE AND A METHOD FOR MANUFACTURING AN ELECTROCHROMIC DEVICE

(71) Applicants: Tohru Yashiro, Kanagawa (JP); Yoshihisa Naijo, Kanagawa (JP); Shigenobu Hirano, Kanagawa (JP); Sukchan Kim, Kanagawa (JP); Koh Fujimura, Tokyo (JP); Kazuaki Tsuji, Kanagawa (JP); Hiroyuki Takahashi, Kanagawa (JP); Yoshinori Okada, Kanagawa (JP); Keiichiroh Yutani, Kanagawa (JP); Tamotsu Horiuchi, Shizuoka (JP)

(72) Inventors: Tohru Yashiro, Kanagawa (JP); Yoshihisa Naijo, Kanagawa (JP); Shigenobu Hirano, Kanagawa (JP); Sukchan Kim, Kanagawa (JP); Koh Fujimura, Tokyo (JP); Kazuaki Tsuji, Kanagawa (JP); Hiroyuki Takahashi, Kanagawa (JP); Yoshinori Okada, Kanagawa (JP); Keiichiroh Yutani, Kanagawa (JP); Tamotsu Horiuchi, Shizuoka (JP)

(73) Assignee: RICOH COMPANY, LTD., Tokyo (JP)

(21) Appl. No.: 14/416,105

(22) PCT Filed: Jul. 22, 2013
(86) PCT No.: PCT/JP2013/070401

§ 371 Date: Jan. 21, 2015

(30) Foreign Application Priority Data
Jul. 23, 2012 (JP) 2012-163015
Nov. 2, 2012 (JP) 2012-242415
Apr. 16, 2013 (JP) 2013-085526

(51) Int. Cl. G02F 1/161; G02F 1/157

(52) U.S. Cl. CPC G02F 1/161; G02F 1/157

(57) ABSTRACT

Disclosed is an electrochromic device that has a first electrode layer, a second electrode layer provided to oppose the first electrode layer, an electrochromic layer provided between the first electrode layer and the second electrode layer, and an electrolyte filling a predetermined region between the first electrode layer and the second electrode layer, wherein a through-hole is formed on at least one layer of the first electrode layer and the second electrode layer and wherein a supporter is provided on only either one side of an outside of the first electrode layer and an outside of the second electrode layer.

### TECHNICAL FIELD

An aspect of the present invention may relate to at least one of an electrochromic device and a method for manufacturing an electrochromic device.

### BACKGROUND ART

A phenomenon wherein an oxidation reduction reaction is reversibly caused by applying a voltage to change a color reversibly is referred to as electrochromism. A device that utilizes such electrochromism is an electrochromic device. For an electrochromic device, many studies have been conducted up to the present date as it may be possible to realize an application resulting from a characteristic of electrochromism.

There is an organic material or an inorganic material as an electrochromic material to be used for an electrochromic device. An organic material may have promise for a color display device because it may be possible to develop a variety of colors due to a molecular structure thereof, but there may be a problem in a durability thereof because it is an organic substance. On the other hand, an inorganic material may have a problem in controlling of a color, but may have an excellent durability, in particular, in a case where a solid electrolyte layer is used. A practical application to a light control glass or an ND filter has been studied by utilizing such a feature as an application wherein a lower chromaticity thereof may be advantageous. However, in a device using a solid electrolyte layer, there may be a problem that a response speed may be lower.

In such an electrochromic device, an oxidation reduction reaction is generally conducted in a configuration wherein an electrochromic material is formed between two opposing electrodes and an electrolyte layer capable of ionic conduction fills between the electrodes. In an electrochromic device, there may be a drawback in such a manner that a response speed of coloration or discoloration may be lower due to a principle wherein coloration or discoloration is conducted by utilizing an oxidation reduction reaction.

Moreover, a performance (an ionic conductance or the like) of an electrolyte layer may influence on a response speed or a memory effect of coloration, because electrochromism is an electrochemical phenomenon. Although a higher responsiveness may readily be obtained in a case where an electrolyte layer is a liquid-like one in such a manner that an electrolyte is dissolved in a solvent, an improvement by solidification or gelation has been studied in view of a strength or reliability of an element.

That is, an electrolyte fluid has conventionally been used in a battery or electrochromic device as an electrochromic element. Accordingly, a separation film in a battery container may be in a partially dried state due to an offset of an electrolyte fluid, as well as leakage of an electrolyte fluid or drying in a battery as caused by vaporization of a solvent, and such a matter may cause elevation of an internal impedance or an internal short-circuit.

In particular, when an electrochromic device is used in a light control glass or a display application, it may be necessary to be sealed with a transparent material such as a glass or a plastic in at least one direction, and accordingly, it may be difficult to close an electrolyte with a metal or the like completely, so that leakage or vaporization of an electrolyte fluid may be a larger problem.

For a method for solving a drawback as described above, it has been proposed that a polymer solid electrolyte is used. For a specific example, it may be possible to provide a solid solution of a matrix polymer that contains an oxyethylene chain or an oxypropylene chain and an inorganic salt, but these may be completely solid and may have a practical problem that an electrical conductance thereof may be several orders of magnitude lower than that of a usual non-aqueous electrolyte fluid although an excellent processibility may be provided.

Furthermore, a method for dissolving an organic electrolyte fluid in a polymer to be a semi-solid state (for example, see Japanese Examined Patent Application No. 3-73081) or a method for conducting a polymerization reaction of a fluidal monomer with an added electrolyte to provide a cross-linked polymer that contains an electrolyte has been proposed in order to improve an electrical conductance of a polymer solid electrolyte. However, none of them have been developed to a practical level.

Meanwhile, such an electrochromic device is generally fabricated by forming an electrochromic material between two opposing electrodes and subsequently interposing and bonding an electrolyte layer capable of ionic conductance. If it is possible to fabricate an electrochromic device without such a bonding process, it may be possible to form a device on various sites such as a curved face so that an applicability thereof may be extended, and a supporter at one side may be unnecessary so that it may be possible to be produced at a lower cost.

However, it may be difficult for a conventional technique to form an electrochromic device on a supporter in a thin-film process. That is, in a case where an electrode is formed on an electrolyte layer in order to omit a bonding process, there may be a problem that a response speed may be lower as mentioned above when an all-solid electrolyte layer is used. Moreover, when an organic material layer is used as an all-solid electrolyte layer, there may be a problem that an electrical resistance of an electrode layer to be formed on an electrolyte layer may readily be higher and it may be impossible to conduct oxidation reduction driving normally. In particular, when a layer of an oxide such as ITO, SnO₂, or AZO that is formed by vacuum film formation and adopted as a transparent electrode generally is film-formed onto a surface of an organic film, both a transparency and an electric conductivity may not readily be compatible.

On the other hand, when an inorganic material layer is used as an all-solid electrolyte layer, a limitation to an inorganic electrochromic compound may be caused. For an example of using an inorganic electrochromic compound, it may be possible to provide an electrochromic element having a structure of a reduction coloration layer and an oxidation coloration layer being opposed and arranged by interposing a solid electrolyte layer therebetween. In such an electrochromic element, the reduction coloration layer is composed of a material that contains a tungsten oxide and a titanium oxide and the oxidation coloration layer is composed of a material that contains a nickel oxide. Moreover, an electrochromic element is disclosed (for example, see Japanese Patent No. 4105537) wherein an intermediate layer that has a transparency and is composed of a metal oxide other than nickel oxides or a metal or a composite of a metal oxide other than nickel oxides and a metal as a main component is arranged between the oxidation coloration layer and the solid electrolyte layer.

In Japanese Patent No. 4105537, it is described that an intermediate layer is formed to improve a repetition characteristic and responsiveness and it may be possible to conduct coloration or discoloration driving for several seconds. However, a structure being complicated and many inorganic chromic compound layers being formed by vacuum film formation may cause size increasing being difficult and cost increasing. Furthermore, in an inorganic electrochromic material, there may be a problem in controlling a color.

### SUMMARY OF THE INVENTION

According to one aspect of the present invention, there is provided an electrochromic device that has a first electrode layer, a second electrode layer provided to oppose the first electrode layer, an electrochromic layer provided between the first electrode layer and the second electrode layer, and an electrolyte filling a predetermined region between the first electrode layer and the second electrode layer, wherein a through-hole is formed on at least one layer of the first electrode layer and the second electrode layer and wherein a supporter is provided on only either one side of an outside of the first electrode layer and an outside of the second electrode layer.

According to another aspect of the present invention, there is provided a method for manufacturing an electrochromic device that has a step of laminating a, first electrode layer and an electrochromic layer on a supporter sequentially, a step of laminating a second electrode layer with a through-hole formed thereon via an insulative porous layer on the electrochromic layer to oppose the first electrode layer, and a step of filling a predetermined region between the first electrode layer and the second electrode layer with an electrolyte from the through-hole.

According to another aspect of the present invention, there is provided a method for manufacturing an electrochromic device that has a step of laminating a first electrode layer on a supporter, a step of laminating a second electrode layer with a through-hole formed thereon via an insulative porous layer on the first electrode layer to oppose the first electrode layer, and a step of filling a predetermined region between the first electrode layer and the second electrode layer with an electrolyte and an electrochromic material from the through-hole.

According to another aspect of the present invention, there is provided an electrochromic device that has a first electrode layer, a second electrode layer provided to oppose the first electrode layer, an electrochromic layer provided to contact the first electrode layer, a degradation prevention layer provided to contact the second electrode layer to prevent degradation of the second electrode layer, and an electrolyte filling between the first electrode layer and the second electrode layer and provided to contact the electrochromic layer and the degradation prevention layer, wherein each of the first electrode layer and the second electrode layer is provided with inner faces being mutually opposing faces and outer faces being faces at opposite sides of the inner faces, wherein a through-hole is formed on at least one electrode layer of the first electrode layer and the second electrode layer, wherein the electrochromic layer or the degradation prevention layer provided on the electrode layer with the through-hole formed thereon is provided on the outer face of the electrode layer with the through-hole formed thereon, and wherein a supporter is provided at only a side of the outer face of either one of the first electrode layer and the second electrode layer.

According to another aspect of the present invention, there is provided a method for manufacturing an electrochromic device that has a step of laminating a first electrode layer and an electrochromic layer on a supporter sequentially, a step of laminating a second electrode layer with a through-hole formed thereon on the electrochromic layer to oppose the first electrode layer, a step of providing a degradation prevention layer to contact a face of the second electrode layer at an opposite side of a face opposing the first electrode layer, and a step of filling a predetermined region between the first electrode layer and the second electrode layer with an electrolyte from the through-hole via the degradation prevention layer.

According to another aspect of the present invention, there is provided a method for manufacturing an electrochromic device that has a step of laminating a second electrode layer and a degradation prevention layer on a supporter sequentially, a step of laminating a first electrode layer with a through-hole formed thereon on the degradation prevention layer to oppose the second electrode layer, a step of providing an electrochromic layer to contact a face of the first electrode layer at an opposite side of a face opposing the second electrode layer, and a step of filling a predetermined region between the first electrode layer and the second electrode layer with an electrolyte from the through-hole via the electrochromic layer.

### BRIEF DESCRIPTION OF THE DRAWINGS

FIG. 1 is a cross-sectional diagram that illustrates an electrochromic device according to a first embodiment.

FIG. 2 is a cross-sectional diagram that illustrates an electrochromic device according to a second embodiment.

FIG. 3 is a cross-sectional diagram that illustrates an electrochromic device according to a third embodiment.

FIG. 4 is a cross-sectional diagram that illustrates an electrochromic device according to a fourth embodiment.

FIG. 5 is a cross-sectional diagram that illustrates an electrochromic device according to a fifth embodiment.

FIG. 6 is a cross-sectional diagram that illustrates an electrochromic device according to a sixth embodiment.

FIG. 7 is a cross-sectional diagram that illustrates an electrochromic device according to a seventh embodiment.

FIG. 8 is a cross-sectional diagram that illustrates an electrochromic device according to an eighth embodiment.

FIG. 9 is a cross-sectional diagram that illustrates an electrochromic device according to a ninth embodiment.

FIG. 10 is a cross-sectional diagram that illustrates an electrochromic device according to a tenth embodiment.

FIG. 11 is a cross-sectional diagram that illustrates an electrochromic device according to an eleventh embodiment.

FIG. 12 is a cross-sectional diagram that illustrates an electrochromic device according to a twelfth embodiment.

FIG. 13 is a cross-sectional diagram that illustrates an electrochromic device according to a thirteenth embodiment.

FIG. 14 is a cross-sectional diagram that illustrates an electrochromic device according to a fourteenth embodiment.

FIG. 15 is a cross-sectional diagram that illustrates an electrochromic device according to a fifteenth embodiment.

FIG. 16 is a cross-sectional diagram that illustrates an electrochromic device according to a sixteenth embodiment.

FIG. 17 is a cross-sectional diagram that illustrates an electrochromic device according to a seventeenth embodiment.

### EXPLANATION OF LETTERS OR NUMERALS

10, 20, 30, 40, 50, 60, 70, 80, 90, 100: electrochromic device
11, 51, 71, 101: supporter
12, 52, 72, 82: first electrode layer
13, 83, 93: electrochromic layer
14, 23, 44: insulative porous layer
15, 55, 75: second electrode layer
16, 66: degradation prevention layer
36, 37: protective layer
67: insulative inorganic protective layer

### EMBODIMENTS FOR IMPLEMENTING THE INVENTION

Hereinafter, descriptions of embodiments will be provided with reference to the drawings. Additionally, an identical reference numeral is provided for an identical component in each drawing and a repeated description(s) may be omitted.

### First Embodiment

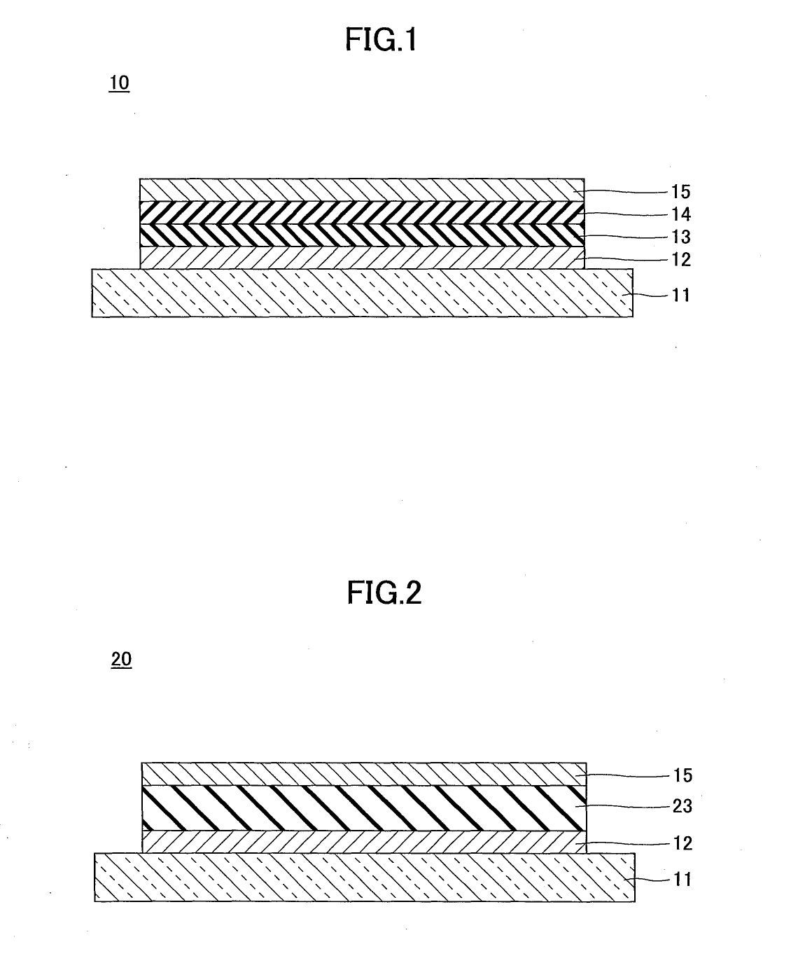

FIG. 1 is a cross-sectional diagram that illustrates an electrochromic device according to a first embodiment. As FIG. 1 is referred to, an electrochromic device 10 has a supporter 11, and a first electrode layer 12, an electrochromic layer 13, an insulative porous layer 14, and a second electrode layer 15 that are laminated on the supporter 11 sequentially.

In the electrochromic device 10, the first electrode layer 12 is provided on the supporter 11 and the electrochromic layer 13 is provided to contact the first electrode layer 12. Moreover, the second electrode layer 15 is provided on the electrochromic layer 13 to oppose the first electrode 12 via the insulative porous layer 14. Additionally, whereas the supporter 11 is provided outside the first electrode layer 12, a supporter is not provided outside the second electrode layer 15.

The insulative porous layer 14 is provided to insulate the first electrode layer 12 and the second electrode layer 15, and the insulative porous layer 14 includes an insulative metal oxide fine particle. The insulative porous layer 14 interposed between the first electrode layer 12 and the second electrode layer 15 is filled with an electrolyte. Furthermore, the second electrode layer 15 is provided with many through-holes that are formed thereon and penetrate in a direction of a thickness thereof.

A process of manufacturing the electrochromic device 10 has a step of laminating the first electrode layer 12 and the electrochromic layer 13 on the supporter 11 sequentially, a step of laminating the second electrode layer 15 with a through-hole formed thereon on the electrochromic layer 13 to oppose the first electrode 12 via the insulative porous layer 14, and a step of filling the insulative porous layer 14 interposed between the first electrode layer 12 and the second electrode layer 15 with an electrolyte from a through-hole formed on the second electrode layer 15.

That is, a through-hole formed on the second electrode layer 15 is an injection hole when the insulative porous layer 14 is filled with an electrolyte in a process of manufacturing the electrochromic device 10. Whereas various problems may be caused by omitting a bonding process in a case where a second electrode layer is formed on an electrolyte layer as described above, it may be possible to avoid such problems by previously laminating the second electrode layer 15 with a through-hole formed thereon on the insulative porous layer 14 and subsequently injecting an electrolyte into the insulative porous layer 14 via a through-hole formed on the second electrode layer 15.

In the electrochromic device 10, coloration, or discoloration of the electrochromic layer 13 due to donation or acceptance of an electric charge or an oxidation reduction reaction may be caused by applying a voltage between the first electrode layer 12 and the second electrode layer 15.

Thus, it may be possible for an electrochromic device according to the first embodiment to fill an insulative porous layer interposed by a first electrode layer and a second electrode layer with an electrolyte via a through-hole formed on the second electrode layer. Accordingly, it may be possible to form a second electrode layer with a lower resistance before being filled with an electrolyte and it may be possible to improve a performance of an electrochromic device.

Furthermore, it may be possible to fabricate an electrochromic device without a bonding process, so that it may be possible to form electrochromic devices on various sites and it may be possible to extend an applicability of an electrochromic device.

Furthermore, a supporter is not provided outside a second electrode layer (or a supporter at one side is unnecessary), so that it may be possible to provide an electrochromic device with an excellent productivity (size increasing). Furthermore, it may be possible to realize an electrochromic device that may be excellent in a responsiveness without a necessity to use an all-solid electrolyte layer and further may also be excellent in a color characteristic by using an organic electrochromic material.

Each component for composing the electrochromic device 10 according to the first embodiment will be described in detail below.

[Supporter 11]

The supporter 11 has a function of supporting the first electrode layer 12, the electrochromic layer 13, the insulative porous layer 14, and the second electrode layer 15. For the supporter 11, it may be possible to use a well-known organic material or inorganic material without change as long as it may be possible to support each of such layers.

For a specific example, it may be possible to use a substrate of a glass such as a no-alkali glass, a borosilicate glass, a float glass, or a soda-lime glass, as the supporter 11. Furthermore, a substrate of a resin such as a polycarbonate resin, an acrylic resin, a poly(ethylene), a poly(vinyl chloride), a polyester, an epoxy resin, a melamine resin, a phenolic resin, a polyurethane resin, or a polyimide resin may be used as the supporter 11. Moreover, a substrate of a metal such as an aluminum, a stainless steel, or a titanium may be used as the supporter 11.

Additionally, when the electrochromic device 10 is a reflection-type display device for viewing from a side of the second electrode layer 15, a transparency of the supporter 11 is unnecessary. Furthermore, when an electrically conductive metal material is used for the supporter 11, it may also be possible for the supporter 11 to be combined with the first electrode layer 12. Furthermore, a surface of the supporter 11 may be coated with a transparent insulative layer, an anti-reflection layer, or the like, in order to improve a moisture vapor barrier property, a gas barrier property, or a visibility.

[First Electrode Layer 12 and Second Electrode Layer 15]

Although a material(s) of the first electrode layer 12 and the second electrode layer 15 is/are not limited as long as such a material(s) has/have an electrical conductivity(ies), it may be necessary to ensure light transparency in a case where utilization as a light control glass is conducted, so that a transparent and electrically conductive material(s) that is/are transparent and more excellent in an electrical conductivity thereof is/are used. Thereby, it may be possible to obtain a transparency of a glass and further improve a contrast of coloring.

For a transparent and electrically conductive material, it may be possible to use an inorganic material such as an indium oxide doped with a tin (referred to as an ITO, below), a tin oxide doped with a fluorine (referred to as an FTO, below), or a tin oxide doped with an antimony (referred to as an ATO, below), and in particular, it may be preferable to use an inorganic material that includes either one of an indium oxide (referred to as an In oxide, below), a tin oxide (referred to as an Sn oxide, below), or a zinc oxide (referred to as a Zn oxide, below) that is formed by a vacuum film formation.

An In oxide, a Sn oxide, and a Zn oxide are materials capable of being readily film-formed by a sputtering method and materials capable of obtaining good transparency and electric conductivity. Furthermore, a particularly preferable material may be an InSnO, a GaZnO, a SnO, an In₂O₃, or a ZnO. Moreover, a network electrode of a silver, a gold, a carbon nanotube, a metal oxide, or the like, that has a transparency, or a composite layer thereof is also useful.

A film thickness of each of the first electrode layer 12 and the second electrode layer 15 is adjusted in such a manner that it may be possible to obtain a value of electrical resistance necessary for an oxidation reduction reaction of the electrochromic layer 13. When an ITO is used for a material of the first electrode layer 12 and the second electrode layer 15, it may be possible for a film thickness of each of the first electrode layer 12 and the second electrode layer 15 to be, for example, about 50-500 nm.

Furthermore, either one of the first electrode layer 12 and the second electrode layer 15 may have a structure having a function of reflection when being utilized as a light control mirror, and in that case, it may be possible for a material(s) of the first electrode layer 12 and the second electrode layer 15 to include a metallic material. For a metallic material, it may be possible to use, for example, a Pt, an Ag, an Au, a Cr, a rhodium, or an alloy thereof, or a laminated layer structure thereof, or the like.

For a method for fabricating each of the first electrode layer 12 and the second electrode layer 15, it may be possible to use a vacuum deposition method, a sputtering method, an ion plating method, or the like. Furthermore, as long as it may be possible to apply and form a material of each of the first electrode layer 12 and the second electrode layer 15, it may be possible to use each kind of printing method such as a spin-coating method, a casting method, a micro-gravure coating method, a gravure coating method, a bar coating method, a roll coating method, a wire-bar coating method, a dip coating method, a slit coating method, a capillary coating method, a spray coating method, a nozzle coating method, a gravure printing method, a screen printing method, a flexo-printing method, an offset printing method, a reverse printing method, an ink jet printing method, or the like.

In the present embodiment, the second electrode layer 15 is provided with many fine through-holes that are formed thereon and penetrate in a direction of a thickness thereof. For example, it may be possible to provide a fine through-hole on the second electrode layer 15 by a method illustrated below. That is, it may be possible to use a method for preliminarily forming a layer having an irregularity as an underlying layer before the second electrode layer 15 is formed so that the second electrode layer 15 having an irregularity is provided directly.

Furthermore, a method may be used for forming a structure with a convex shape such as a micro-pillar before the second electrode layer 15 is formed and removing the structure with a convex shape after the second electrode layer 15 is formed. Furthermore, a method may be used for distributing a foamable polymer or the like before the second electrode layer 15 is formed and applying a treatment such as heating or degassing thereto to be foamed after the second electrode layer 15 is formed. Furthermore, a method may be used for directly irradiating the second electrode layer 15 with each kind of radiation ray to form a pore.

For a method for forming a fine through-hole on the second electrode layer 15, a colloidal lithography method may be preferable. A colloidal lithography method is a method for distributing a fine particle on an underlying layer to be laminated with the second electrode layer 15, forming an electrically conductive film as the second electrode layer 15 on a face with the fine particle distributed thereon by a vacuum film formation method or the like while the distributed fine particle is provided as a mask, and subsequently removing the electrically conductive film together with the fine particle to conduct patterning.

It may be possible to readily form a fine through-hole on the second electrode layer 15 by a colloidal lithography method. In particular, a diameter of a fine particle to be distributed is greater than or equal to a film thickness of the second electrode layer 15, so that it may be possible to readily form a though-hole on the second electrode layer 15. Furthermore, it may be possible to change a concentration of a fine particle dispersion to be distributed or a particle diameter of a fine particle to readily adjust a density or surface area of a fine through-hole.

Moreover, it may be possible to readily improve an in-plane uniformity of a colloidal mask by a method for distributing a fine particle dispersion, so that it may be possible to improve an in-plane uniformity of a coloration or discoloration density of the electrochromic layer 13 and improve a display performance. A specific content of a colloidal lithography method will be described below.

For a material of a fine particle for a colloidal mask to be used in a colloidal lithography, any one may be used as long as it may be possible to form a fine through-hole on the second electrode layer 15, and for example, a SiO₂ fine particle or the like may be economically superior. Furthermore, for a dispersion to be used for distributing a colloidal mask, one with a good dispersion property may be preferable, and for example, it may be possible to use an aqueous dispersion in a case where a SiO₂ fine particle is used as a fine particle for a colloidal mask.

However, when an underlying layer for a colloidal mask, such as the electrochromic layer 13 or the insulative porous layer 14 is likely to be damaged, it may be preferable to use a SiO₂ fine particle with a surface treated in such a manner that a fine particle for a colloidal mask is dispersed in a non-aqueous solvent. In such a case, it may be possible to use a non-aqueous dispersion as a dispersion to be used for distributing a colloidal mask.

It may be preferable for a particle size (diameter) of a fine particle for a colloidal mask to be greater than or equal to a film thickness of the second electrode layer 15 to be formed with a fine through-hole and less than or equal to a film thickness of the electrochromic layer 13. It may be possible to remove a colloidal mask by an ultrasonic wave irradiation method, a tape peeling method, or the like, and it may be preferable to select a method that causes a less damage on an underlying layer. Furthermore, dry cleaning due to spraying of a fine particle or the like may also be possible for another method for removing a colloidal mask.

When a colloidal mask is removed by using a tape peeling method, a thickness of an adhesive layer of a general tape is greater than or equal to 1 μm, so that a colloidal mask may frequently be embedded therein. In such a case, an adhesive layer contacts a surface of the second electrode layer 15, so that it may be preferable to use a tape with a less amount of a remaining adhesive. When a colloidal mask is removed by using an ultrasonic wave irradiation method, it may be preferable to use a solvent that causes a less damage to each already formed functional layer, as a dipping solvent.

For a method for forming a fine through-hole on the second electrode layer 15, a general lift-off method that uses a photo-resist, a dry film, or the like may be used other than a colloidal lithography method. Specifically, the method is to first form a desired photo-resist pattern, then form the second electrode layer 15, and subsequently remove the photo-resist pattern, so that an undesired portion of the photo-resist pattern is removed and a fine through-hole is formed on the second electrode layer 15.

When a fine through-hole is formed on the second electrode layer 15 by a general lift-off method, it may be preferable to use a negative type photo-resist to be used so that a light-irradiated surface area of an object may be small in order to avoid a light-irradiation-caused damage on an underlying layer.

For a negative type photo-resist, it may be possible to provide, for example, a poly(vinyl cinnamate), a styrylpyridinium formalized poly(vinyl alcohol), a glycol methacrylate/poly(vinyl alcohol)/initiator, a poly(glycidyl methacrylate), a halomethylated poly(styrene), a diazoresin, a bisazide/diene-type rubber, a poly(hydroxystyrene)/melamine/photo-acid generotor, a methylated melamine resin, a methylated urea resin, or the like.

It may be preferable for a diameter of a fine through-hole provided on the second electrode layer 15 to be greater than or equal to 10 nm and less than or equal to 100 μm. If a diameter of a though-hole is less than 10 nm (0.01 μm), a deficiency may be caused in that penetration of an electrolyte ion may be degraded. Furthermore, if a diameter of a fine through-hole is greater than 100 μm, it is at a visible level (a size of one pixel electrode level in a usual display) and a deficiency may be caused in a display performance directly above a fine through-hole.

It may be possible to appropriately set a ratio of a surface area of a pore of a fine through-hole provided on the second electrode layer 15 to a surface area of the second electrode layer 15 (hole density), and it may be possible to be, for example, about 0.01-40%. If a hole density is too high, a surface resistance of the second electrode layer 15 may increase, so that a deficiency may be caused in that a chromic defect may be caused because a surface area of a region with no second electrode layer 15 is increased. Furthermore, if a hole density is too low, a deficiency may similarly be caused in that a problem may be caused in driving because a penetrability of an electrolyte ion may be degraded.

Additionally, degradation prevention layers may be formed on opposing surfaces of the first electrode layer 12 and second electrode layer 15. A degradation prevention layer is not particularly limited as long as a material is provided for serving to prevent corrosion of the first electrode layer 12 and second electrode layer 15 due to an irreversible oxidation reduction reaction. For example, it may be possible to use Al₂O₃, SiO₂, or an insulator material that includes it/them. Furthermore, a zinc oxide, a titanium oxide, or a semiconductor material that includes it/them may be used. Furthermore, an organic material such as a polyimide may be used.

For a method for forming a degradation prevention layer, it may be possible to use a vacuum deposition method, a sputtering method, an ion plating method, or the like. Furthermore, as long as it may be possible to apply or form a material of a degradation prevention layer, it may be possible to use each kind of printing method such as a spin-coating method, a casting method, a micro-gravure coating method, a gravure coating method, a bar coating method, a roll coating method, a wire bar coating method, a dip coating method, a slit coating method, a capillary coating method, a spray coating method, a nozzle coating method, a gravure printing method, a screen printing method, a flexo-printing method, an offset printing method, a reverse printing method, or an ink jet printing method.

In particular, it may be useful to form a material that reversely reacts with the electrochromic layer 13 and exhibits a reversible oxidation reduction reaction, on the second electrode layer 15 that opposes the electrochromic layer 13. For example, it may be possible to fix a fine particle of an electrically conductive or semi-conductive metal oxide such as an antimony tin oxide or a nickel oxide on the second electrode layer 15 by, for example, an acryl-type, alkyd-type, isocyanate-type, urethane-type, epoxy-type, or phenol-type binder or the like.

[Electrochromic Layer 13]

The electrochromic layer 13 is a layer that includes an electrochromic material, wherein any of inorganic electrochromic compounds and organic electrochromic compounds may be used for such an electrochromic material. Furthermore, an electrically conductive polymer may be used that is known to exhibit electrochromism.

For an inorganic electrochromic compound, it may be possible to provide, for example, a tungsten oxide, a molybdenum oxide, an iridium oxide, a titanium oxide, or the like. Furthermore, for an organic electrochromic compound, it may be possible to provide, for example, a viologen, a rare-earth phthalocyanine, a styryl, or the like. Furthermore, for an electrically conductive polymer, it may be possible to provide, for example, a poly(pyrrole), a poly(thiophene), a poly(aniline), or a derivative thereof, or the like.

Furthermore, it may be particularly desirable to use a structure that carries an organic electrochromic compound on an electrically conductive or semi-conductive fine particle, for the electrochromic layer 13. Specifically, a structure is such that a fine particle with a particle diameter of about 5 nm-50 nm is sintered on an electrode surface and an organic electrochromic compound that has a polar group such as a phosphonic acid, a carboxyl group, or a silanol group is adsorbed on a surface of such a fine particle.

The present structure is such that an electron may efficiently be injected into an organic electrochromic compound by utilizing a larger surface effect of a fine particle, so that a high-speed response may be possible as compared with a conventional electrochromic display element. Moreover, it may be possible to form a transparent film as a display layer by using a fine particle, so that it may be possible to obtain a higher coloration density of an electrochromic dye. Furthermore, it may also be possible to carry plural kinds of organic electrochromic compounds on an electrically conductive or semi-conductive fine particle.

Specifically, it may be possible to use a polymer-type one, or as a dye-type electrochromic compound, an organic electrochromic compound of a lower-molecule-type such as an azobenzene-type, an anthraquinone-type, a diarylethene-type, a dihydroprene-type, a dipyridine-type, a styryl-type, a styrylspiropyran-type, a spirooxazine-type, a spirothiopyran-type, a thioindigo-type, a tetrathiafulvalene-type, a terephthalic acid-type, a triphenylmethane-type, a triphenylamine-type, a naphthopyran-type, a viologen-type, a pyrazoline-type, a phenazine-type, a phenylenediamine-type, a phenoxadine-type, a phenothiazine-type, a phthalocyanine-type, a fluoran-type, a fulgide-type, a benzopyran-type, or a metallocene-type, or an electrically conductive polymer compound such as a poly(aniline) or a poly(thiophene).

Among ones described above, it may be particularly preferable to include a viologen-type compound or dipyridine-type compound that may have a lower electric potential for coloration or discoloration and exhibit a good color value. For example, it may be preferable to include a dipyridine compound represented by formula [chem 1] (general formula) of:

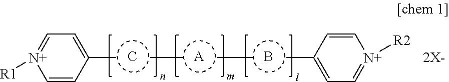

Additionally, in formula [chem 1] (general formula), each of R1 and R2 independently represents an alkyl group with a carbon number of 1 to 8 that may have a substituent or an aryl group, wherein at least one of R1 and R2 has a substituent selected from COOH, PO(OH)₂, or Si (OCₖH₂ₖ₊₁)₃. X represents a monovalent anion. n, m, or 1 represents 0, 1, or 2. Each of A, B, and C independently represents an alkyl group with a carbon number of 1 to 20 that may have a substituent, an aryl group, or a hetrocyclic group.

On the other hand, for a metal complex-type or metal oxide-type electrochromic compound, it may be possible to use an inorganic-type electrochromic compound such as a titanium oxide, a vanadium oxide, a tungsten oxide, an indium oxide, an iridium oxide, a nickel oxide, or Prussian blue.

An electrically conductive or semi-conductive fine particle is not particularly limited and it may be preferable to use a metal oxide. For a specific material, it may be possible to use a metal oxide based on a titanium oxide, a zinc oxide, a tin oxide, a zirconium oxide, a cerium oxide, a yttrium oxide, a boron oxide, a magnesium oxide, a strontium titanate, a potassium titanate, a barium titanate, a calcium titanate, a calcium oxide, a ferrite, a hafnium oxide, a tungsten oxide, an iron oxide, a copper oxide, a nickel oxide, a cobalt oxide, a barium oxide, a strontium oxide, a vanadium oxide, an aluminosilicate, a calcium phosphate, an aluminosilicate, or the like.

Furthermore, such a metal oxide may be used singly or two or more kinds thereof may be mixed and used. As an electrical characteristic such as an electrical conductivity or a physical characteristic such as an optical property is taken into consideration, a color display that may be excellent in a response speed of coloration or discoloration may be possible when one kind selected from a titanium oxide, a zinc oxide, a tin oxide, a zirconium oxide, an iron oxide, a magnesium oxide, an indium oxide, and a tungsten oxide, or a mixture thereof is used. Particularly, when a titanium oxide is used, a color display that may be more excellent in a response speed of coloration or discoloration may be possible.

Furthermore, a shape of an electrically conductive or semi-conductive fine particle is not particularly limited, and a shape with a larger surface area per unit volume (specific surface area, below) is used in order to carry an electrochromic compound efficiently. For example, when a fine particle is an aggregate of nanoparticles that has a larger specific surface area, an electrochromic compound may be carried thereon more efficiently so that a display contrast ratio of coloration or discoloration may be excellent.

It may be possible for a film thickness of the electrochromic layer 13 to be, for example, about 0.2-5.0 μm. If a film thickness of the electrochromic layer 13 is less than the aforementioned range, it may be difficult to obtain a certain coloration density. Furthermore, if a film thickness of the electrochromic layer 13 is greater than the aforementioned range, a manufacturing cost may be increased and a visibility may readily be degraded due to coloring. It may also be possible to form the electrochromic layer 13 and an electrically conductive or semi-conductive fine particle layer by a vacuum film formation, and it may be preferable to apply and form a particle dispersion paste in view of productivity.

[Electrolyte]

In the present embodiment, an electrolyte as an electrolytic solution fills an insulative porous layer 14 arranged between the first electrode layer 12 and the second electrode layer 15 from a fine through-hole formed on the second electrode layer 15. For an electrolytic solution, it may be possible to use a liquid electrolyte such as an ionic liquid or a solution provided by dissolving a solid electrolyte in a solvent.

For a material of an electrolyte, it may be possible to use, for example, an inorganic ion salt such as an alkali metal salt or an alkaline earth metal salt, a quaternary ammonium salt, or a supporting electrolyte such as an acid or an alkali. Specifically, it may be possible to use LiClO₄, LiBF₄, LiAsF₆, LiPF₆, LiCF₃SO₃, LiCF₃COO, KCl, NaClO₃, NaCl, NaBF₄, NaSCN, KBF₄, Mg(ClO₄)₂, Mg(BF₄)₂, or the like.

Furthermore, it may also be possible to use an ionic liquid. An ionic liquid may be any of substances that have been studied or reported generally. In particular, for an organic ionic liquid, a molecular structure is provided that exhibits a liquid phase in a wide temperature range that includes room temperature. For an example of a molecular structure, it may be possible to provide, as a cationic component, an aromatic salt such as an imidazole derivative such as an N,N-dimethylimidazole salt, an N,N-methylethylimidazole salt, or an N,N-methylpropylimidazole salt or a pyridinium derivative such as an N,N-dimethylpyridinium salt or an N,N-methylpropylpyridinium salt, or an aliphatic quaternary ammonium-type one such as a tetraalkylammonium such as a trimethylpropylammonium salt, a trimethylhexylammonium salt, or a triethylhexylammonium salt.

For an anionic component, a compound that contains a fluorine may be favorable from the viewpoint of a stability in atmosphere and it may be possible to provide BF₄⁻, CF₃SO₃⁻, PF₄⁻, (CF₃SO₂)_{2N}⁻ or the like. It may be possible to use an ionic liquid formulated based on a combination of such a cationic component and such an anionic component.

Furthermore, for an example of a solvent, it may be possible to use a propylene carbonate, an acetonitrile, a γ-butyrolactone, an ethylene carbonate, a sulfolane, a dioxolane, a tetrahydrofuran, a 2-methyltetrahydrofuran, a dimethyl sulfoxide, a 1,2-dimethoxyethane, a 1,2-ethoxymethoxyethane, a poly(ethylene glycol), an alcohol, a mixed solvent thereof, or the like.

Furthermore, an electrolytic solution is not necessarily a liquid with a lower viscosity and it may be possible to be various forms such as a gel-like or cross-linked polymer type or a liquid crystal dispersion type. It may be preferable to form a gel-like or solid-like electrolytic solution from the viewpoint of improvement of a strength of an element, an improvement of a reliability, or prevention of diffusion of coloration. For a solidification method, a method for holding an electrolyte and a solvent in a polymer resin may be preferable. That is because it may be possible to obtain a higher ionic conductance and solid strength. Moreover, it may be preferable to use a photo-curable resin for a polymer resin. That is because it may be possible to manufacture an element at a lower temperature and a shorter period of time than a thermal polymerization or a method for evaporating a solvent to provide a thin film.

[Insulative Porous Layer 14]

The insulative porous layer 14 has a function of separating the first electrode layer 12 and the second electrode layer 15 to be insulated electrically and holding an electrolyte. A material of the insulative porous layer 14 is not particularly limited as long as it is porous, and it may be preferable to use an organic material or inorganic material that may have a higher insulation property and durability and may be excellent in a film formation property, or a composite thereof.

For a method for forming the insulative porous layer 14, it may be possible to use a sintering method (wherein a pore is utilized that is produced between particles by adding a binder or the like to polymer fine particles or inorganic particles to be partially fused), an extraction method (wherein a constitutive layer is formed by an organic substance or inorganic substance soluble in a solvent, a binder insoluble in the solvent, and the like and subsequently the organic substance or inorganic substance is dissolved by the solvent to obtain a pore), or the like.

Furthermore, a formation method such as a foaming method for heating or degassing a polymer or the like to be foamed, a phase conversion method for operating a good solvent and a poor solvent to cause phase separation of a mixture of polymers, or a radiation ray irradiation method for conducting irradiation with each kind of radiation ray to form a pore may be used for a method for forming the insulative porous layer 14. For a specific example, it may be possible to provide a polymer particle mixing film that includes a metal oxide fine particle (a SiO₂ particle, an Al₂O₃ particle, or the like) and a polymer binding agent, a porous organic film (such as a poly(urethane) resin or a poly(ethylene) resin), an inorganic insulation material film formed to be porous-film-like, or the like.

An irregularity of the insulative porous layer 14 also depends on a film thickness of the second electrode layer 15, wherein, for example, if a film thickness of the second electrode layer 15 is 100 nm, it may be necessary to satisfy a requirement that a surface roughness of the insulative porous layer 14 is less than 100 nm as an average roughness (Ra). If an average roughness is greater than 100 nm, a surface resistance of the second electrode layer 15 may be lost greatly to cause display failure. It may be possible for a film thickness of the insulative porous layer 14 to be, for example, about 50-500 nm.

Furthermore, it may be preferable to use the insulative porous layer 14 in combination with an inorganic film. This is because when the second electrode layer 15 to be formed on a surface of the insulative porous layer 14 is formed by a sputtering method, a damage on an organic substance of the insulative porous layer 14 or electrochromic layer 13 as an underlying layer may be reduced.

For the aforementioned inorganic film, it is preferable to use a material that includes at least ZnS. ZnS has a feature in that it may be possible to conduct film formation at a high speed by a sputtering method without causing damage on the electrochromic layer 13 or the like. Moreover, ZnS—SiO₂, ZnS—SiC, ZnS—Si, ZnS—Ge, or the like may be used for a material that includes a ZnS as a main component.

Herein, it is preferable for a content of ZnS to be approximately 50-90 mol % in order to keep a good crystallinity at a time when an insulation layer is formed. Therefore, a particularly preferable material is ZnS—SiO₂ (8/2), ZnS—SiO₂ (7/3), ZnS, or ZnS—ZnO—In₂O₃—Ga₂O₃ (60/23/10/7). It may be possible to obtain a thin film with a good insulation effect and prevent degradation of a film strength or peeling of a film by using a material as described above for the insulative porous layer 14.

### Second Embodiment

A second embodiment illustrates an electrochromic device with a layer structure different from that of the first embodiment. Additionally, a description(s) for a component identical to that of an already described embodiment may be omitted in the second embodiment.

FIG. 2 is a cross-sectional diagram that illustrates an electrochromic device according to the second embodiment. As referring to FIG. 2, an electrochromic device 20 according to the second embodiment is different from the electrochromic device 10 according to the first embodiment (see FIG. 1) in that the electrochromic layer 13 and the insulative porous layer 14 are replaced with an insulative porous layer 23.

The insulative porous layer 23 is provided to insulate the first electrode 12 and the second electrode 15 and the insulative porous layer 23 includes an insulative metal oxide fine particle. The insulative porous layer 23 interposed between the first electrode layer 12 and the second electrode layer 15 is filled with an electrolyte and an electrochromic material. That is, the insulative porous layer 23 in the present embodiment also functions as an electrochromic layer. Therefore, the insulative porous layer 23 may be restated as an electrochromic layer.

A process for manufacturing the electrochromic device 20 has a step of laminating the first electrode layer 12 on the supporter 11, a step of laminating the second electrode layer 15 with a through-hole formed thereon on the first electrode layer 12 via the insulative porous layer 23 to oppose the first electrode layer 12, and a step of filling the insulative porous layer 23 interposed between the first electrode layer 12 and the second electrode layer 15 with an electrolyte and an electrochromic material from a through-hole formed on the second electrode layer 15.

That is, a through-hole formed on the second electrode layer 15 in a process for manufacturing the electrochromic device 20 is an injection hole for filling the insulative porous layer 23 with an electrolyte and an electrochromic material. Additionally, it may be necessary to dissolve an electrolyte and an electrochromic material in a solvent or the like to be applied as a solution.

Thus, it may be possible for an electrochromic device according to the second embodiment to further exert the following effect(s) in addition to an effect of the first embodiment. That is, a layer structure of an electrochromic device may be simplified, so that it may be possible to improve a productivity thereof.

### Third Embodiment

A third embodiment illustrates an electrochromic device with a layer structure different from that of the first embodiment. Additionally, a description(s) for a component identical to that of an already described embodiment may be omitted in the third embodiment.

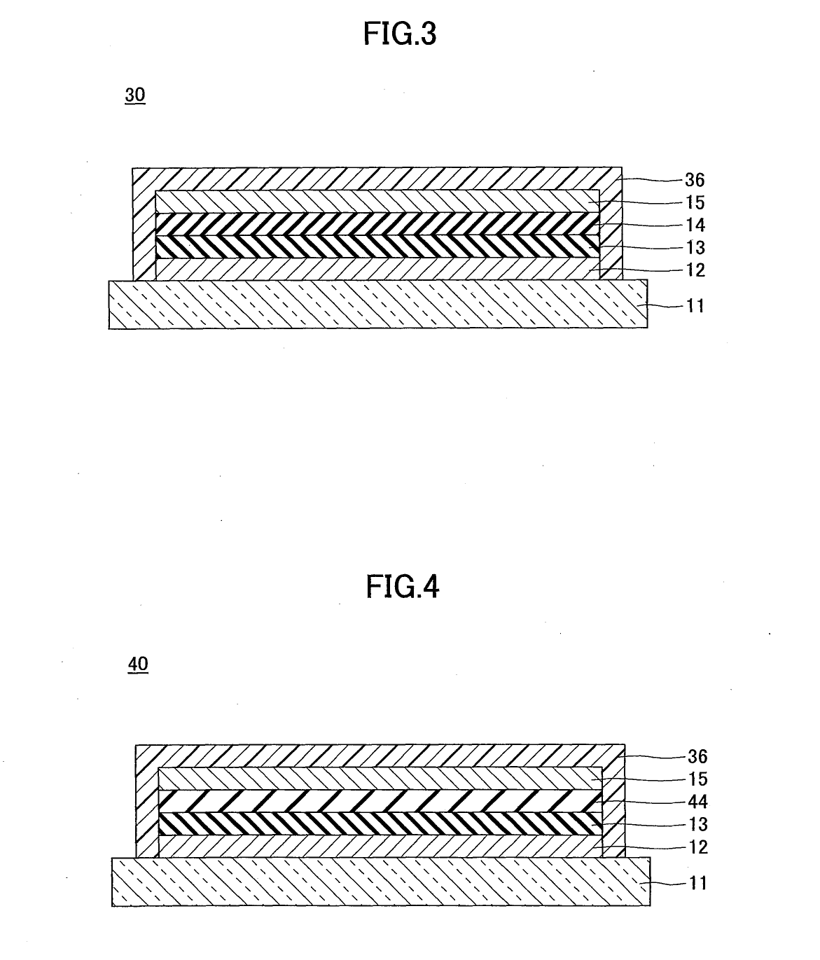

FIG. 3 is a cross-sectional diagram that illustrates an electrochromic device according to the third embodiment. As referring to FIG. 3, an electrochromic device 30 according to the third embodiment is different from the electrochromic device 10 according to the first embodiment (see FIG. 1) in that a protective layer 36 is added thereto.

The protective layer 36 is formed on the supporter 11 so as to cover a side face of the first electrode layer 12, a side face of the electrochromic layer 13, a side face of the insulative porous layer 14, and a side face and a top face of the second electrode layer 15. It may be possible to form the protective layer 36 by, for example, applying onto the supporter 11 and subsequently curing an ultraviolet ray curable or thermosetting insulative resin or the like so as to cover a side face of the first electrode layer 12, a side face of the electrochromic layer 13, a side face of the insulative porous layer 14, and a side face and a top face of the second electrode layer 15. It may be possible for a film thickness of the protective layer 36 to be, for example, about 0.5-10 μm.

Thus, it may be possible for an electrochromic device according to the third embodiment to further exert the following effect(s) in addition to an effect of the first embodiment. That is, it may be possible to protect a second electrode layer or the like from damage or an electrical hindrance by forming a protective layer. Furthermore, it may be possible to prevent leakage of an electrolyte and improve durability by forming a protective layer. It may be more preferable to provide a protective layer with an ultraviolet ray cutting function or an antistatic function.

### Fourth Embodiment

A fourth embodiment illustrates an electrochromic device with a layer structure different from that of the first embodiment. Additionally, a description(s) for a component identical to that of an already described embodiment may be omitted in the fourth embodiment.

FIG. 4 is a cross-sectional diagram that illustrates an electrochromic device according to the fourth embodiment. As referring to FIG. 4, an electrochromic device 40 according to the fourth embodiment is different from the electrochromic device 10 according to the first embodiment (see FIG. 1) in that the insulative porous layer 14 is replaced with an insulative porous layer 44.

The insulative porous layer 44 is a layer that further contains a white color pigment particle in the insulative porous layer 14, and functions as a white color reflective layer. For a material of a white color pigment particle, it may be possible to use, for example, a titanium oxide, an aluminum oxide, a zinc oxide, a silica, a cesium oxide, an yttrium oxide, or the like.

Thus, it may be possible for an electrochromic device according to the fourth embodiment to further exert the following effect(s) in addition to an effect of the first embodiment. That is, it may be possible to readily realize a reflection-type display element by containing a white color pigment particle in an insulative porous layer to function as a white color reflective layer.

### Fifth Embodiment

A fifth embodiment illustrates an electrochromic device with a layer structure different from that of the first embodiment. Additionally, a description(s) for a component identical to that of an already described embodiment may be omitted in the fifth embodiment.

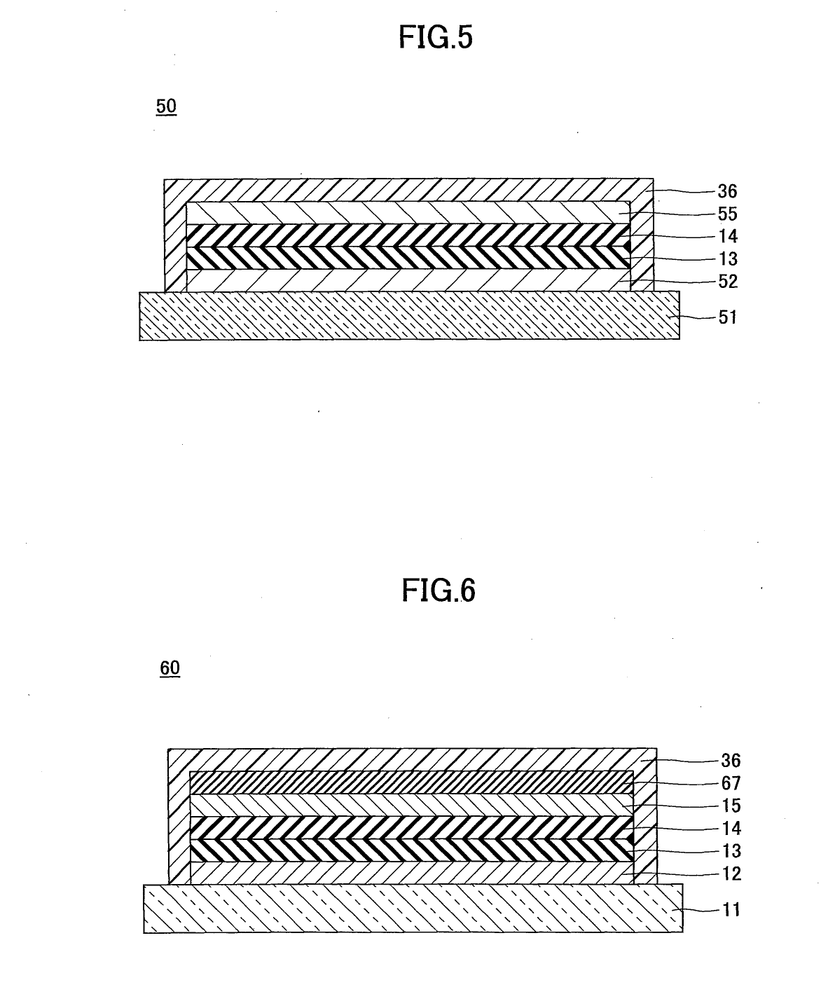

FIG. 5 is a cross-sectional diagram that illustrates an electrochromic device according to the fifth embodiment. As referring to FIG. 5, an electrochromic device 50 according to the fifth embodiment is different from the electrochromic device 10 according to the first embodiment (see FIG. 1) in that the supporter 11, the first electrode layer 12, and the second electrode layer 15 are replaced with a supporter 5, a first electrode layer 52, and a second electrode layer 55, respectively.

Similarly to the second electrode layer 15 of the electrochromic device 10, fine through-holes are formed on the supporter 51 and the first electrode layer 52. That is, the supporter 51 with a fine through-hole formed thereon is provided outside the first electrode layer 52 with a fine through-hole formed thereon. On the other hand, a fine through-hole is not formed on the second electrode layer 55 (similarly to the first electrode layer 12 of the electrochromic device 10).

Thus, it may be possible for an electrochromic device according to the fifth embodiment to further exert the following effect(s) in addition to an effect of the first embodiment. That is, it may be possible to fill an insulative porous layer with an electrolyte from a side of a supporter via an electrochromic layer by forming fine through-holes on both the supporter and a first electrode layer formed on the supporter. As a result, it may be possible to form electrochromic devices on various sites, and it may be possible to further extend an applicability of an electrochromic device. Additionally, it may be possible to fill an insulative porous layer with an electrolyte from a gap in an electrochromic material that forms an electrochromic layer.

### Sixth Embodiment

A sixth embodiment illustrates an electrochromic device with a layer structure different from that of the first embodiment. Additionally, a description(s) for a component identical to that of an already described embodiment may be omitted in the sixth embodiment.

FIG. 6 is a cross-sectional diagram that illustrates an electrochromic device according to the sixth embodiment. As referring to FIG. 6, an electrochromic device 60 according to the sixth embodiment is different from the electrochromic device 10 according to the first embodiment (see FIG. 1) in that an insulative inorganic protective layer 67 is added on the second electrode layer 15.

For a material of the insulative inorganic protective layer 67, it may be possible to use, for example, a metal oxide, a metal sulfide, or a metal nitride, that is a general insulative material, or the like. A particularly preferable material of the insulative inorganic protective layer 67 is SiO₂, SiN, Al₂O₃, ZnS, ZnS—SiO₂ (8/2), ZnS—SiO₂ (7/3), or the like. It may be possible for a film thickness of the insulative inorganic protective layer 67 to be, for example, about 0.05-1 μm.

Thus, it may be possible for an electrochromic device according to the sixth embodiment to further exert the following effect(s) in addition to an effect of the first embodiment. That is, it may be possible to protect a second electrode layer from an electrical hindrance effectively due to a thin film structure thereof, by forming an insulative inorganic protective layer on the second electrode layer. Furthermore, it may be possible to prevent diffusion of an electric charge on a second electrode layer efficiently and improve durability thereof.

### Seventh Embodiment

A seventh embodiment illustrates an electrochromic device with each layer formed on a supporter different from those of the first to sixth embodiments. Additionally, a description(s) for a component identical to that of an already described embodiment may be omitted in the seventh embodiment.

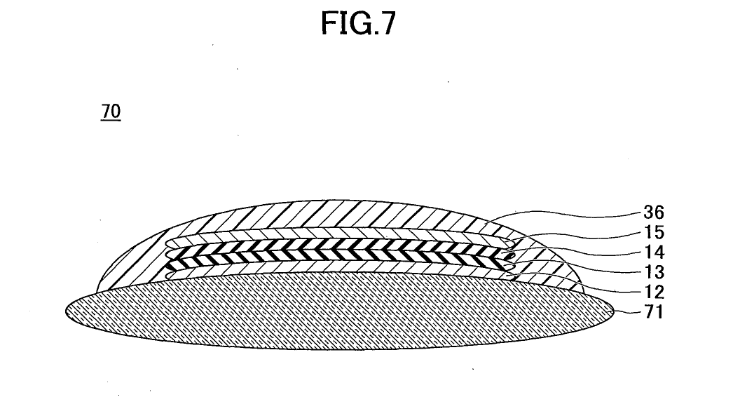

FIG. 7 is a cross-sectional diagram that illustrates an electrochromic device according to the seventh embodiment. As referring to FIG. 7, an electrochromic device 70 according to the seventh embodiment is different from the electrochromic device 30 according to the third embodiment (see FIG. 3) in that the supporter 11 is replaced with a supporter 71.

The supporter 71 is an optical lens. A face that forms each layer of the supporter 71 is a curved face, so that it may be extremely difficult to form each layer in a conventional method of bonding two supporters while an electrolytic solution is interposed therebetween. On the other hand, in the present embodiment, it may be possible to laminate and form each layer by a manufacturing method that does not have an already described bonding process, similarly to a case where a layer formation face of a supporter is a plane face, even though a layer formation face of a supporter is a curved face. Additionally, the supporter 71 may be an eyeglass or the like.

Thus, it may be possible for an electrochromic device according to the seventh embodiment to further exert the following effect(s) in addition to an effect of the first embodiment. That is, it may be possible to use a supporter wherein a face for forming each layer is a curved face, so that it may be possible to select an optical element that has a curved face, such as an optical lens or an eyeglass, as a supporter. It may be possible to realize an electrochromic device capable of controlling light readily (an electrically light controllable optical device) by using an optical element such as an optical lens or an eyeglass.

### Eighth Embodiment

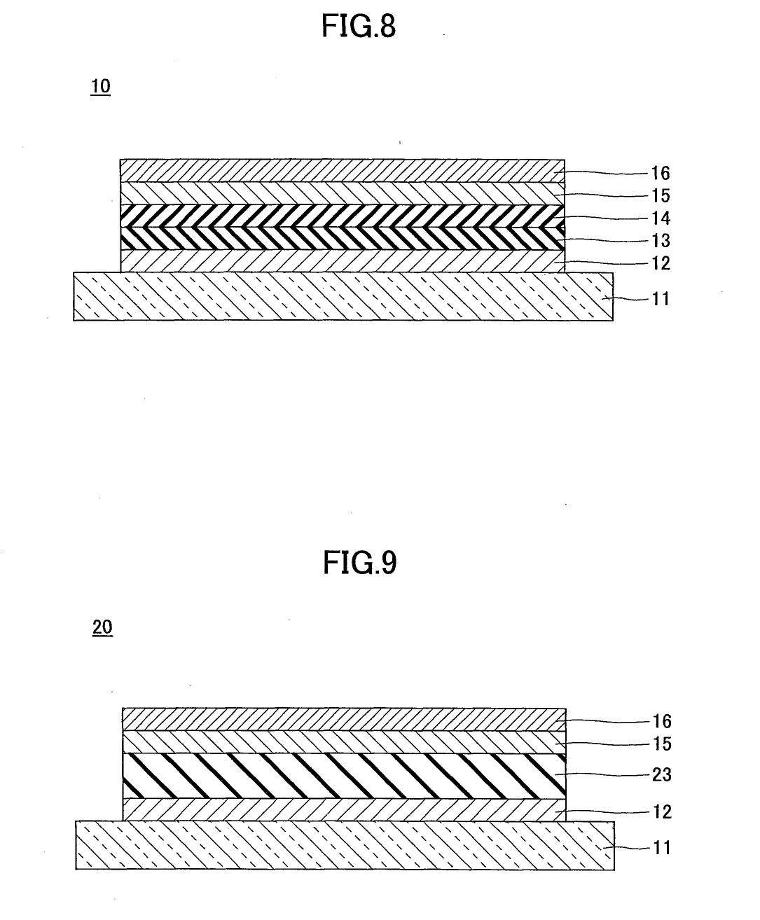

FIG. 8 is a cross-sectional diagram that illustrates an electrochromic device according to an eighth embodiment. As FIG. 8 is referred to, an electrochromic device 10 has a supporter 11, and a first electrode layer 12, an electrochromic layer 13, an insulative porous layer 14, a second electrode layer 15, and a degradation prevention layer 16 that are laminated on the supporter 11 sequentially.

In the electrochromic device 10, the first electrode layer 12 is provided on the supporter 11 and the electrochromic layer 13 is provided to contact the first electrode layer 12. Furthermore, the second electrode layer 15 is provided on the electrochromic layer 13 to oppose the first electrode 12 via the insulative porous layer 14.

The insulative porous layer 14 is provided to insulate the first electrode layer 12 and the second electrode layer 15, and the insulative porous layer 14 includes an insulative metal oxide fine particle. The insulative porous layer 14 interposed between the first electrode layer 12 and the second electrode layer 15 is filled with an electrolyte. Furthermore, the second electrode layer 15 is provided with many through-holes that are formed thereon and penetrate in a direction of a thickness thereof. The degradation prevention layer 16 is provided outside the second electrode layer 15 and the degradation prevention layer 16 includes a semi-conductive metal oxide fine particle.

Additionally, for the sake of convenience, faces that oppose each other are referred to as inner faces and a face at an opposite side of each inner face is referred to as an outer face in each of the first electrode layer 12 and the second electrode layer 15. In the present embodiment, an inner face of the first electrode layer 12 contacts the electrochromic layer 13 and an outer face of the first electrode layer 12 contacts the supporter 11. Furthermore, an inner face of the second electrode layer 15 contacts the insulative porous layer 14 and an outer face of the second electrode layer 15 contacts the degradation prevention layer 16. Additionally, an inner face and an outer face may be planar faces or may be curved faces.

A process of manufacturing the electrochromic device 10 has a step of laminating the first electrode layer 12 and the electrochromic layer 13 on the supporter 11 sequentially, a step of laminating the second electrode layer 15 with a through-hole formed thereon on the electrochromic layer 13 to oppose the first electrode 12 via the insulative porous layer 14, a step of laminating the degradation prevention layer 16 on the second electrode layer 15, and a step of filling the insulative porous layer 14 interposed between the first electrode layer 12 and the second electrode layer 15 with an electrolyte from a through-hole formed on the second electrode layer 15 via the degradation prevention layer 16.

That is, a through-hole formed on the second electrode layer 15 is an injection hole when the insulative porous layer 14 is filled with an electrolyte in a process of manufacturing the electrochromic device 10. Whereas various problems may be caused by omitting a bonding process in a case where a second electrode layer is formed on an electrolyte layer as described above, it may be possible to avoid such problems by a step of previously laminating the second electrode layer 15 with a through-hole formed thereon on the insulative porous layer 14, laminating the degradation prevention layer 16, and subsequently injecting an electrolyte into the insulative porous layer 14 via the degradation prevention layer 16 and a through-hole formed on the second electrode layer 15.

In the electrochromic device 10, coloration or discoloration of the electrochromic layer 13 due to donation or acceptance of an electric charge or an oxidation reduction reaction may be caused by applying a voltage between the first electrode layer 12 and the second electrode layer 15.

Thus, it may be possible for an electrochromic device according to the eighth embodiment to fill an insulative porous layer interposed by a first electrode layer and a second electrode layer with an electrolyte via the degradation prevention layer and a through-hole formed on the second electrode layer. Accordingly, it may be possible to form a second electrode layer with a lower resistance before being filled with an electrolyte and it may be possible to improve a performance of an electrochromic device.

Furthermore, it may be possible to fabricate an electrochromic device without a bonding process, so that it may be possible to form electrochromic devices on various sites and it may be possible to extend an applicability of an electrochromic device.

Furthermore, a supporter is not provided outside a degradation prevention layer (or a supporter at one side is unnecessary), so that it may be possible to provide an electrochromic device with an excellent productivity (size increasing). Furthermore, it may be possible to realize an electrochromic device that may be excellent in a responsiveness without a necessity to use an all-solid electrolyte layer and further may also be excellent in a color characteristic by using an organic electrochromic material.

Furthermore, a degradation prevention layer is provided on a second electrode layer, so that it may be possible to realize an electrochromic device that operates repeatedly and stably.

Additionally, a through-hole is formed on a second electrode layer in the present embodiment, so that it may be possible to form a degradation prevention layer outside the second electrode layer (or outside two opposing electrode layers) so as to contact the second electrode layer. This may be because it may be possible for an ion to move between a front and a back of a second electrode layer via a through-hole formed on the second electrode layer. As a result, it may be unnecessary to form a degradation prevention layer on an underlying layer for a second electrode layer, so that it may be possible to avoid a risk of damaging a degradation prevention layer. This point will be described in more detail below.

It may also be possible to form a degradation prevention layer on an underlying layer for a second electrode layer with a through-hole formed thereon (or insides of two opposing electrode layers). However, as a degradation prevention layer is formed on an underlying layer for a second electrode layer, a material that composes a degradation prevention layer may be damaged by, for example, sputtering for forming a second electrode later on a degradation prevention layer, an ultrasonic wave for removing a colloidal mask, or the like, in a colloidal lithography method.

Then, a degradation prevention layer is provided on an overlying layer for a second electrode layer with a through-hole formed thereon (or outsides of two opposing electrode layers), so that it may be possible to avoid a problem that a material of a degradation prevention layer may be damaged. However, a material of a degradation prevention layer may have a less process damage, and when such a material is used, a degradation prevention layer may be formed on an underlying layer for a second electrode layer with a through-hole formed thereon (or insides of two opposing electrode layers). In other words, a degradation prevention layer is provided on an overlying layer for a second electrode layer with a through-hole formed thereon (or outsides of two opposing electrode layers), so that it may be possible to increase a freedom of selection of a material that composes a degradation prevention layer.

Furthermore, when a degradation prevention layer is formed, it may be possible to select a process capable of forming a homogenous degradation prevention layer appropriately when formation thereof is made on either a permeable insulative porous layer or on a second electrode layer.

Each component for composing the electrochromic device 10 according to the eighth embodiment will be described in detail below.

[Supporter 11]

The supporter 11 has a function of supporting the first electrode layer 12, the electrochromic layer 13, the insulative porous layer 14, the second electrode layer 15, and the degradation prevention layer 16. For the supporter 11, it may be possible to use a well-known organic material or inorganic material without change as long as it may be possible to support each of such layers.

For a specific example, it may be possible to use a substrate of a glass such as a no-alkali glass, a borosilicate glass, a float glass, or a soda-lime glass, as the supporter 11. Furthermore, a substrate of a resin such as a polycarbonate resin, an acrylic resin, a poly(ethylene), a poly(vinyl chloride), a polyester, an epoxy resin, a melamine resin, a phenolic resin, a polyurethane resin, or a polyimide resin may be used as the supporter 11. Moreover, a substrate of a metal such as an aluminum, a stainless steel, or a titanium may be used as the supporter 11.

Additionally, when the electrochromic device 10 is a reflection-type display device for viewing from a side of the second electrode layer 15, a transparency of the supporter 11 is unnecessary. Furthermore, when an electrically conductive metal material is used for the supporter 11, it may also be possible for the supporter 11 to be combined with the first electrode layer 12. Furthermore, a surface of the supporter 11 may be coated with a transparent insulative layer, an anti-reflection layer, or the like, in order to improve a moisture vapor barrier property, a gas barrier property, or a visibility.

[First Electrode Layer 12 and Second Electrode Layer 15]

Although a material(s) of the first electrode layer 12 and the second electrode layer 15 is/are not limited as long as such a material(s) has/have an electrical conductivity(ies), it may be necessary to ensure light transparency in a case where utilization as a light control glass is conducted, so that a transparent and electrically conductive material(s) that is/are transparent and more excellent in an electrical conductivity thereof is/are used. Thereby, it may be possible to obtain a transparency of a glass and further improve a contrast of coloring.

For a transparent and electrically conductive material, it may be possible to use an inorganic material such as an indium oxide doped with a tin (referred to as an ITO, below), a tin oxide doped with a fluorine (referred to as an FTO, below), or a tin oxide doped with an antimony (referred to as an ATO, below). In particular, it may be preferable to use an inorganic material that includes either one of an indium oxide (referred to as an In oxide, below), a tin oxide (referred to as an Sn oxide, below), or a zinc oxide (referred to as a Zn oxide, below) that is formed by a vacuum film formation.

An In oxide, a Sn oxide, and a Zn oxide are materials capable of being readily film-formed by a sputtering method and materials capable of obtaining good transparency and electric conductivity. Furthermore, a particularly preferable material may be an InSnO, a GaZnO, a SnO, an In₂O₃, or a ZnO. Moreover, a network electrode of a silver, a gold, a carbon nanotube, a metal oxide, or the like, that has a transparency, or a composite layer thereof is also useful. Additionally, a network electrode is an electrode provided by forming a carbon nanotube, another highly electrically conductive non-transparent material, or the like, into a fine network-like one to have a transmittance thereof.

A film thickness of each of the first electrode layer 12 and the second electrode layer 15 is adjusted in such a manner that it may be possible to obtain a value of electrical resistance necessary for an oxidation reduction reaction of the electrochromic layer 13. When an ITO is used for a material of the first electrode layer 12 and the second electrode layer 15, it may be possible for a film thickness of each of the first electrode layer 12 and the second electrode layer 15 to be, for example, about 50-500 nm.

Furthermore, either one of the first electrode layer 12 and the second electrode layer 15 may have a structure having a function of reflection when being utilized as a light control mirror, and in that case, it may be possible for a material(s) of the first electrode layer 12 and the second electrode layer 15 to include a metallic material. For a metallic material, it may be possible to use, for example, a Pt, an Ag, an Au, a Cr, a rhodium, or an alloy thereof, or a laminated layer structure thereof, or the like.

For a method for fabricating each of the first electrode layer 12 and the second electrode layer 15, it may be possible to use a vacuum deposition method, a sputtering method, an ion plating method, or the like. Furthermore, as long as it may be possible to apply and form a material of each of the first electrode layer 12 and the second electrode layer 15, it may be possible to use each kind of printing method such as a spin-coating method, a casting method, a micro-gravure coating method, a gravure coating method, a bar coating method, a roll coating method, a wire-bar coating method, a dip coating method, a slit coating method, a capillary coating method, a spray coating method, a nozzle coating method, a gravure printing method, a screen printing method, a flexo-printing method, an offset printing method, a reverse printing method, an ink jet printing method, or the like.

In the present embodiment, the second electrode layer 15 is provided with many fine through-holes that are formed thereon and penetrate in a direction of a thickness thereof. For example, it may be possible to provide a fine through-hole on the second electrode layer 15 by a method illustrated below. That is, it may be possible to use a method for preliminarily forming a layer having an irregularity as an underlying layer before the second electrode layer 15 is formed so that the second electrode layer 15 having an irregularity is provided directly.

Furthermore, a method may be used for forming a structure with a convex shape such as a micro-pillar before the second electrode layer 15 is formed and removing the structure with a convex shape after the second electrode layer 15 is formed. Furthermore, a method may be used for distributing a foamable polymer or the like before the second electrode layer 15 is formed and applying a treatment such as heating or degassing thereto to be foamed after the second electrode layer 15 is formed. Furthermore, a method may be used for directly irradiating the second electrode layer 15 with each kind of radiation ray to form a pore.

For a method for forming a fine through-hole on the second electrode layer 15, a colloidal lithography method may be preferable. A colloidal lithography method is a method for distributing a fine particle on an underlying layer to be laminated with the second electrode layer 15, forming an electrically conductive film as the second electrode layer 15 on a face with the fine particle distributed thereon by a vacuum film formation method or the like while the distributed fine particle is provided as a mask, and subsequently removing the electrically conductive film together with the fine particle to conduct patterning.

It may be possible to readily form a fine through-hole on the second electrode layer 15 by a colloidal lithography method. In particular, a diameter of a fine particle to be distributed is greater than or equal to a film thickness of the second electrode layer 15, so that it may be possible to readily form a though-hole on the second electrode layer 15. Furthermore, it may be possible to change a concentration of a fine particle dispersion to be distributed or a particle diameter of a fine particle to readily adjust a density or surface area of a fine through-hole.

Moreover, it may be possible to readily improve an in-plane uniformity of a colloidal mask by a method for distributing a fine particle dispersion, so that it may be possible to improve an in-plane uniformity of a coloration or discoloration density of the electrochromic layer 13 and improve a display performance. A specific content of a colloidal lithography method will be described below.

For a material of a fine particle for a colloidal mask to be used in a colloidal lithography, any one may be used as long as it may be possible to form a fine through-hole on the second electrode layer 15, and for example, a SiO₂ fine particle or the like may be economically superior. Furthermore, for a dispersion to be used for distributing a colloidal mask, one with a good dispersion property may be preferable, and for example, it may be possible to use an aqueous dispersion in a case where a SiO₂ fine particle is used as a fine particle for a colloidal mask.

However, when an underlying layer for a colloidal mask, such as the electrochromic layer 13 or the insulative porous layer 14 is likely to be damaged, it may be preferable to use a SiO₂ fine particle with a surface treated in such a manner that a fine particle for a colloidal mask is dispersed in a non-aqueous solvent. In such a case, it may be possible to use a non-aqueous dispersion as a dispersion to be used for distributing a colloidal mask.

It may be preferable for a particle size (diameter) of a fine particle for a colloidal mask to be greater than or equal to a film thickness of the second electrode layer 15 to be formed with a fine through-hole and less than or equal to a film thickness of the electrochromic layer 13. It may be possible to remove a colloidal mask by an ultrasonic wave irradiation method, a tape peeling method, or the like, and it may be preferable to select a method that causes a less damage on an underlying layer. Furthermore, dry cleaning due to spraying of a fine particle or the like may also be possible for another method for removing a colloidal mask.

When a colloidal mask is removed by using a tape peeling method, a thickness of an adhesive layer of a general tape is greater than or equal to 1 μm, so that a colloidal mask may frequently be embedded therein. In such a case, an adhesive layer contacts a surface of the second electrode layer 15, so that it may be preferable to use a tape with a less amount of a remaining adhesive. When a colloidal mask is removed by using an ultrasonic wave irradiation method, it may be preferable to use a solvent that causes a less damage to each already formed functional layer, as a dipping solvent.

For a method for forming a fine through-hole on the second electrode layer 15, a general lift-off method that uses a photo-resist, a dry film, or the like may be used other than a colloidal lithography method. Specifically, the method is to first form a desired photo-resist pattern, then form the second electrode layer 15, and subsequently remove the photo-resist pattern, so that an undesired portion of the photo-resist pattern is removed and a fine through-hole is formed on the second electrode layer 15.

When a fine through-hole is formed on the second electrode layer 15 by a general lift-off method, it may be preferable to use a negative type photo-resist to be used so that a light-irradiated surface area of an object may be small in order to avoid a light-irradiation-caused damage on an underlying layer.

For a negative type photo-resist, it may be possible to provide, for example, a poly(vinyl cinnamate), a styrylpyridinium formalized poly(vinyl alcohol), a glycol methacrylate/poly(vinyl alcohol)/initiator, a poly(glycidyl methacrylate), a halomethylated poly(styrene), a diazoresin, a bisazide/diene-type rubber, a poly(hydroxystyrene)/melamine/photo-acid generotor, a methylated melamine resin, a methylated urea resin, or the like.

Moreover, it may also be possible to form a fine through-hole on the second electrode layer 15 by a processing device that uses laser light. In general, when a laser processing is used, a pore diameter of a fine through-hole to be formed is greater than or equal to 15 μM.

It may be preferable for a diameter of a fine through-hole provided on the second electrode layer 15 to be greater than or equal to 10 nm and less than or equal to 100 μm. If a diameter of a though-hole is less than 10 nm (0.01 μm), a deficiency may be caused in that penetration of an electrolyte ion may be degraded. Furthermore, if a diameter of a fine through-hole is greater than 100 μm, it is at a visible level (a size of one pixel electrode level in a usual display) and a deficiency may be caused in a display performance directly above a fine through-hole.

It may be possible to appropriately set a ratio of a surface area of a pore of a fine through-hole provided on the second electrode layer 15 to a surface area of the second electrode layer 15 (hole density), and it may be possible to be, for example, about 0.01-40%. If a hole density is too high, a surface resistance of the second electrode layer 15 may increase, so that a deficiency may be caused in that a chromic defect may be caused because a surface area of a region with no second electrode layer 15 is increased. Furthermore, if a hole density is too low, a deficiency may similarly be caused in that a problem may be caused in driving because a penetrability of an electrolyte ion may be degraded.

[Electrochromic Layer 13]

The electrochromic layer 13 is a layer that includes an electrochromic material, wherein any of inorganic electrochromic compounds and organic electrochromic compounds may be used for such an electrochromic material. Furthermore, an electrically conductive polymer may be used that is known to exhibit electrochromism.

For an inorganic electrochromic compound, it may be possible to provide, for example, a tungsten oxide, a molybdenum oxide, an iridium oxide, a titanium oxide, or the like. Furthermore, for an organic electrochromic compound, it may be possible to provide, for example, a viologen, a rare-earth phthalocyanine, a styryl, or the like. Furthermore, for an electrically conductive polymer, it may be possible to provide, for example, a poly(pyrrole), a poly(thiophene), a poly(aniline), or a derivative thereof, or the like.

Furthermore, it may be particularly desirable to use a structure that carries an organic electrochromic compound on an electrically conductive or semi-conductive fine particle, for the electrochromic layer 13. Specifically, a structure is such that a fine particle with a particle diameter of about 5 nm-50 nm is sintered on an electrode surface and an organic electrochromic compound that has a polar group such as a phosphonic acid, a carboxyl group, or a silanol group is adsorbed on a surface of such a fine particle.

The present structure is such that an electron may efficiently be injected into an organic electrochromic compound by utilizing a larger surface effect of a fine particle, so that a high-speed response may be possible as compared with a conventional electrochromic display element. Moreover, it may be possible to form a transparent film as a display layer by using a fine particle, so that it may be possible to obtain a higher coloration density of an electrochromic dye. Furthermore, it may also be possible to carry plural kinds of organic electrochromic compounds on an electrically conductive or semi-conductive fine particle.

Specifically, it may be possible to use a polymer-type one, or as a dye-type electrochromic compound, an organic electrochromic compound of a lower-molecule-type such as an azobenzene-type, an anthraquinone-type, a diarylethene-type, a dihydroprene-type, a dipyridine-type, a styryl-type, a styrylspiropyran-type, a spirooxazine-type, a spirothiopyran-type, a thioindigo-type, a tetrathiafulvalene-type, a terephthalic acid-type, a triphenylmethane-type, a triphenylamine-type, a naphthopyran-type, a viologen-type, a pyrazoline-type, a phenazine-type, a phenylenediamine-type, a phenoxadine-type, a phenothiazine-type, a phthalocyanine-type, a fluoran-type, a fulgide-type, a benzopyran-type, or a metallocene-type, or an electrically conductive polymer compound such as a poly(aniline) or a poly(thiophene).

Among ones described above, it may be particularly preferable to include a viologen-type compound or dipyridine-type compound that may have a lower electric potential for coloration or discoloration and exhibit a good color value. For example, it may be preferable to include a dipyridine compound represented by formula [chem 1] (general formula) of:

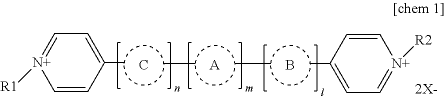

Additionally, in formula [chem 1] (general formula), each of R1 and R2 independently represents an alkyl group with a carbon number of 1 to 8 that may have a substituent or an aryl group, wherein at least one of R1 and R2 has a substituent selected from COOH, PO(OH)₂, or Si (OCₖH₂ₖ₊₁)₃. X represents a monovalent anion. n, m, or 1 represents 0, 1, or 2. Each of A, B, and C independently represents an alkyl group with a carbon number of 1 to 20 that may have a substituent, an aryl group, or a hetrocyclic group.

On the other hand, for a metal complex-type or metal oxide-type electrochromic compound, it may be possible to use an inorganic-type electrochromic compound such as a titanium oxide, a vanadium oxide, a tungsten oxide, an indium oxide, an iridium oxide, a nickel oxide, or Prussian blue.

An electrically conductive or semi-conductive fine particle is not particularly limited and it may be preferable to use a metal oxide. For a specific material, it may be possible to use a metal oxide based on a titanium oxide, a zinc oxide, a tin oxide, a zirconium oxide, a cerium oxide, a yttrium oxide, a boron oxide, a magnesium oxide, a strontium titanate, a potassium titanate, a barium titanate, a calcium titanate, a calcium oxide, a ferrite, a hafnium oxide, a tungsten oxide, an iron oxide, a copper oxide, a nickel oxide, a cobalt oxide, a barium oxide, a strontium oxide, a vanadium oxide, an aluminosilicate, a calcium phosphate, an aluminosilicate, or the like.

Furthermore, such a metal oxide may be used singly or two or more kinds thereof may be mixed and used. As an electrical characteristic such as an electrical conductivity or a physical characteristic such as an optical property is taken into consideration, a color display that may be excellent in a response speed of coloration or discoloration may be possible when one kind selected from a titanium oxide, a zinc oxide, a tin oxide, a zirconium oxide, an iron oxide, a magnesium oxide, an indium oxide, and a tungsten oxide, or a mixture thereof is used. Particularly, when a titanium oxide is used, a color display that may be more excellent in a response speed of coloration or discoloration may be possible.

Furthermore, a shape of an electrically conductive or semi-conductive fine particle is not particularly limited, and a shape with a larger surface area per unit volume (specific surface area, below) is used in order to carry an electrochromic compound efficiently. For example, when a fine particle is an aggregate of nanoparticles that has a larger specific surface area, an electrochromic compound may be carried thereon more efficiently so that a display contrast ratio of coloration or discoloration may be excellent.

It may be possible for a film thickness of the electrochromic layer 13 to be, for example, about 0.2-5.0 If a film thickness of the electrochromic layer 13 is less than the aforementioned range, it may be difficult to obtain a certain coloration density. Furthermore, if a film thickness of the electrochromic layer 13 is greater than the aforementioned range, a manufacturing cost may be increased and a visibility may readily be degraded due to coloring. It may also be possible to form the electrochromic layer 13 and an electrically conductive or semi-conductive fine particle layer by a vacuum film formation, and it may be preferable to apply and form a particle dispersion paste in view of productivity.

[Electrolyte]

In the present embodiment, an electrolyte (not-illustrated) as an electrolytic solution fills an insulative porous layer 14 arranged between the first electrode layer 12 and the second electrode layer 15 from a fine through-hole formed on the second electrode layer 15 via the degradation prevention layer 16. That is, an electrolyte (not-illustrated) is provided to fill between the first electrode layer 12 and the second electrode layer 15 to contact the electrochromic layer 13 and contact the degradation prevention layer 16 via a through-hole formed on the second electrode layer 15. For an electrolytic solution, it may be possible to use a liquid electrolyte such as an ionic liquid or a solution provided by dissolving a solid electrolyte in a solvent.

For a material of an electrolyte, it may be possible to use, for example, an inorganic ion salt such as an alkali metal salt or an alkaline earth metal salt, a quaternary ammonium salt, or a supporting electrolyte such as an acid or an alkali. Specifically, it may be possible to use LiClO₄, LiBF₄, LiAsF₆, LiPF₆, LiCF₃SO₃, LiCF₃COO, KCl, NaClO₃, NaCl, NaBF₄, NaSCN, KBF₄, Mg(ClO₄)₂, Mg(BF₄)₂, or the like.

Furthermore, it may also be possible to use an ionic liquid. An ionic liquid may be any of substances that have been studied or reported generally. In particular, for an organic ionic liquid, a molecular structure is provided that exhibits a liquid phase in a wide temperature range that includes room temperature. For an example of a molecular structure, it may be possible to provide, as a cationic component, an aromatic salt such as an imidazole derivative such as an N,N-dimethylimidazole salt, an N,N-methylethylimidazole salt, or an N,N-methylpropylimidazole salt or a pyridinium derivative such as an N,N-dimethylpyridinium salt or an N,N-methylpropylpyridinium salt, or an aliphatic quaternary ammonium-type one such as a tetraalkylammonium such as a trimethylpropylammonium salt, a trimethylhexylammonium salt, or a triethylhexylammonium salt.

For an anionic component, a compound that contains a fluorine may be favorable from the viewpoint of a stability in atmosphere and it may be possible to provide BF₄⁻, CF₃SO₃⁻, PF₄⁻, (CF₃SO₂)_{2N}⁻, or the like. It may be possible to use an ionic liquid formulated based on a combination of such a cationic component and such an anionic component.

Furthermore, for an example of a solvent, it may be possible to use a propylene carbonate, an acetonitrile, a γ-butyrolactone, an ethylene carbonate, a sulfolane, a dioxolane, a tetrahydrofuran, a 2-methyltetrahydrofuran, a dimethyl sulfoxide, a 1,2-dimethoxyethane, a 1,2-ethoxymethoxyethane, a poly(ethylene glycol), an alcohol, a mixed solvent thereof, or the like.

Furthermore, an electrolytic solution is not necessarily a liquid with a lower viscosity and it may be possible to be various forms such as a gel-like or cross-linked polymer type or a liquid crystal dispersion type. It may be preferable to form a gel-like or solid-like electrolytic solution from the viewpoint of improvement of a strength of an element, an improvement of a reliability, or prevention of diffusion of coloration. For a solidification method, a method for holding an electrolyte and a solvent in a polymer resin may be preferable. That is because it may be possible to obtain a higher ionic conductance and solid strength. Moreover, it may be preferable to use a photo-curable resin for a polymer resin. That is because it may be possible to manufacture an element at a lower temperature and a shorter period of time than a thermal polymerization or a method for evaporating a solvent to provide a thin film.

[Insulative Porous Layer 14]

The insulative porous layer 14 has a function of separating the first electrode layer 12 and the second electrode layer 15 to be insulated electrically and holding an electrolyte. A material of the insulative porous layer 14 is not particularly limited as long as it is porous, and it may be preferable to use an organic material or inorganic material that may have a higher insulation property and durability and may be excellent in a film formation property, or a composite thereof.

For a method for forming the insulative porous layer 14, it may be possible to use a sintering method (wherein a pore is utilized that is produced between particles by adding a binder or the like to polymer fine particles or inorganic particles to be partially fused), an extraction method (wherein a constitutive layer is formed by an organic substance or inorganic substance soluble in a solvent, a binder insoluble in the solvent, and the like and subsequently the organic substance or inorganic substance is dissolved by the solvent to obtain a pore), or the like.

Furthermore, a formation method such as a foaming method for heating or degassing a polymer or the like to be foamed, a phase conversion method for operating a good solvent and a poor solvent to cause phase separation of a mixture of polymers, or a radiation ray irradiation method for conducting irradiation with each kind of radiation ray to form a pore may be used for a method for forming the insulative porous layer 14. For a specific example, it may be possible to provide a polymer particle mixing film that includes a metal oxide fine particle (a SiO₂ particle, an Al₂O₃ particle, or the like) and a polymer binding agent, a porous organic film (such as a poly(urethane) resin or a poly(ethylene) resin), an inorganic insulation material film formed to be porous-film-like, or the like.

An irregularity of the insulative porous layer 14 also depends on a film thickness of the second electrode layer 15, wherein, for example, if a film thickness of the second electrode layer 15 is 100 nm, it may be necessary to satisfy a requirement that a surface roughness of the insulative porous layer 14 is less than 100 nm as an average roughness (Ra). If an average roughness is greater than 100 nm, a surface resistance of the second electrode layer 15 may be lost greatly to cause display failure. It may be possible for a film thickness of the insulative porous layer 14 to be, for example, about 50-500 nm.

Furthermore, it may be preferable to use the insulative porous layer 14 in combination with an inorganic film. This is because when the second electrode layer 15 to be formed on a surface of the insulative porous layer 14 is formed by a sputtering method, a damage on an organic substance of the insulative porous layer 14 or electrochromic layer 13 as an underlying layer may be reduced.

For the aforementioned inorganic film, it may be preferable to use a material that includes at least ZnS. ZnS has a feature in that it may be possible to conduct film formation at a high speed by a sputtering method without causing damage on the electrochromic layer 13 or the like. Moreover, ZnS—SiO₂, ZnS—SiC, ZnS—Si, ZnS—Ge, or the like may be used for a material that includes a ZnS as a main component.

Herein, it may be preferable for a content of ZnS to be approximately 50-90 mol % in order to keep a good crystallinity at a time when an insulation layer is formed. Therefore, a particularly preferable material is ZnS—SiO₂ (8/2), ZnS—SiO₂ (7/3), ZnS, or ZnS—ZnO—In₂O₃—Ga₂O₃ (60/23/10/7). It may be possible to obtain a thin film with a good insulation effect and prevent degradation of a film strength or peeling of a film by using a material as described above for the insulative porous layer 14.

[Degradation Prevention Layer 16]

A role of the degradation prevention layer 16 is to conduct a chemical reaction that is a reverse of that of the electrochromic layer 13 to attain a charge balance so that corrosion or degradation of the second electrode layer 15 due to an irreversible oxidation reduction reaction may be suppressed, and as a result, a stability of repetition of the electrochromic display device 10 may be improved. Additionally, a reverse reaction also includes acting as a capacitor in addition to a case where a degradation prevention layer conducts oxidation or reduction.

A material of the degradation prevention layer 16 is not particularly limited as long as the material has a role of preventing corrosion caused by an irreversible oxidation reduction reaction of the first electrode layer 12 and the second electrode layer 15. For a material of the degradation prevention layer 16, it may be possible to use, for example, an electrically conductive or semi-conductive metal oxide that includes an antimony tin oxide, a nickel oxide, a titanium oxide, a zinc oxide, a tin oxide, or a plurality thereof. Moreover, when coloring of a degradation prevention layer is not problematic, it may be possible to use an electrochromic material identical to that described above.

It may be possible for the degradation prevention layer 16 to be composed of a porous thin film or a permeable thin film that may generally not inhibit injection of an electrolyte. For example, a fine particle of an electrically conductive or semi-conductive metal oxide such as an antimony tin oxide, a nickel oxide, a titanium oxide, a zinc oxide, or a tin oxide, is fixed on the second electrode layer 15 by, for example, an acryl-type, alkyd-type, isocyanate-type, urethane-type, epoxy-type, or phenol-type binder or the like, so that it may be possible to obtain a preferable porous thin film that satisfies a permeability for an electrolyte and a function as a degradation prevention layer.

In particular, when an electrochromic device is fabricated as an optical element such as a lens wherein a transparency thereof may be required, it may be preferable to use an n-type semi-conductive oxide (or n-type semi-conductive metal oxide) fine particle with a higher transparency as the degradation prevention layer 16. For a specific example, it may be possible to use a particle of a compound that includes a titanium oxide, a tin oxide, a zinc oxide, or a plurality thereof or a mixture thereof, that is composed of a particle with a primary particle diameter less than or equal to 100 nm.

Moreover, when such a degradation prevention layer 16 is used, it may be preferable for the electrochromic layer to be of a material that changes from a colored state to a transparent state due to an oxidation reaction. That is because an n-type semi-conductive metal oxide may readily be reduced (or subjected to electron injection) while an electrochromic layer conducts an oxidation reaction, and it may be possible to reduce a driving voltage.

In such a manner, a particularly preferable electrochromic material may be an organic polymer material. It may be possible to readily form a film by an application and formation process or the like, and it may be possible to adjust or control a color depending on a molecular structure. Specific examples of such an organic polymer material are disclosed in Chemistry of Materials review 2011. 23, 397-415 Navigating the Color Palette of Solution-Processable Electrochromic Polymers (Reynolds), Macromolecules 1996. 29 7629-7630 (Reynolds), and Polymer journal, Vol. 41, No. 7, Electrochromic Organic Metallic Hybrid Polymers (Higuchi), and the like.

An example of such an organic polymer material is a poly(3,4-ethylenedioxythiophene)-type material, a complex formation polymer of a bis(terpyridine) and an iron ion, or the like.

For a method for forming the degradation prevention layer 16, it may be possible to use a vacuum deposition method, a sputtering method, an ion plating method, or the like. Furthermore, as long as it may be possible to apply and form a material of the degradation prevention layer 16, it may be possible to use each kind of printing method, such as a spin-coating method, a casting method, a micro-gravure coating method, a gravure coating method, a bar coating method, a roll coating method, a wire bar coating method, a dip coating method, a slit coating method, a capillary coating method, a spray coating method, a nozzle coating method, a gravure printing method, a screen printing method, a flexo-printing method, an offset printing method, a reverse printing method, or an ink jet printing method.

### Ninth Embodiment

A ninth embodiment illustrates an electrochromic device with a layer structure different from that of the eighth embodiment. Additionally, a description(s) for a component identical to that of an already described embodiment may be omitted in the ninth embodiment.

FIG. 9 is a cross-sectional diagram that illustrates an electrochromic device according to the ninth embodiment. As referring to FIG. 9, an electrochromic device 20 according to the ninth embodiment is different from the electrochromic device 10 according to the eighth embodiment (see FIG. 8) in that the electrochromic layer 13 and the insulative porous layer 14 are replaced with an insulative porous layer 23.

In the present embodiment, an inner face of the first electrode layer 12 contacts the insulative porous layer 23 and an outer face of the first electrode layer 12 contacts the supporter 11. Furthermore, an inner face of the second electrode layer 15 contacts the insulative porous layer 23 and an outer face of the second electrode layer 15 contacts the degradation prevention layer 16. Additionally, a through-hole is not formed on the first electrode layer 12 but a through-hole is formed on the second electrode layer 15, similarly to the eighth embodiment.

The insulative porous layer 23 is provided to insulate the first electrode 12 and the second electrode 15 and the insulative porous layer 23 includes an insulative metal oxide fine particle. The insulative porous layer 23 interposed between the first electrode layer 12 and the second electrode layer 15 is filled with an electrolyte and an electrochromic material. That is, the insulative porous layer 23 in the present embodiment also functions as an electrochromic layer. Therefore, the insulative porous layer 23 may be restated as an electrochromic layer.

A process for manufacturing the electrochromic device 20 has a step of laminating the first electrode layer 12 on the supporter 11, a step of laminating the second electrode layer 15 with a through-hole formed thereon on the first electrode layer 12 via the insulative porous layer 23 to oppose the first electrode layer 12, a step of laminating the degradation prevention layer 16 on the second electrode layer 15, and a step of filling the insulative porous layer 23 interposed between the first electrode layer 12 and the second electrode layer 15 with an electrolyte and an electrochromic material from a through-hole formed on the second electrode layer 15 through the degradation prevention layer 16.

That is, a through-hole formed on the second electrode layer 15 in a process for manufacturing the electrochromic device 20 is an injection hole for filling the insulative porous layer 23 with an electrolyte and an electrochromic material. Additionally, it may be necessary to dissolve an electrolyte and an electrochromic material in a solvent or the like to be applied as a solution.

Thus, it may be possible for an electrochromic device according to the ninth embodiment to further exert the following effect(s) in addition to an effect of the eighth embodiment. That is, a layer structure of an electrochromic device may be simplified, so that it may be possible to improve a productivity thereof.

### Tenth Embodiment

A tenth embodiment illustrates an electrochromic device with a layer structure different from that of the eighth embodiment. Additionally, a description(s) for a component identical to that of an already described embodiment may be omitted in the tenth embodiment.

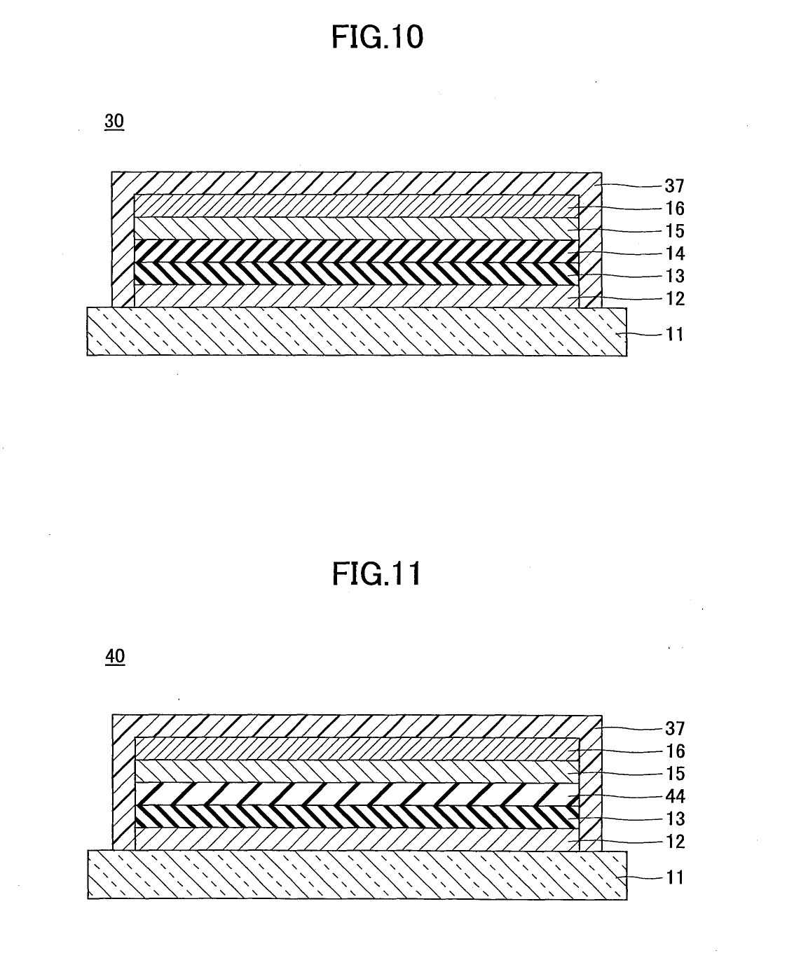

FIG. 10 is a cross-sectional diagram that illustrates an electrochromic device according to the tenth embodiment. As referring to FIG. 10, an electrochromic device 30 according to the tenth embodiment is different from the electrochromic device 10 according to the eight embodiment (see FIG. 8) in that a protective layer 37 is added thereto.

In the present embodiment, an inner face of the first electrode layer 12 contacts the electrochromic layer 13 and an outer face of the first electrode layer 12 contacts the supporter 11. Furthermore, an inner face of the second electrode layer 15 contacts the insulative porous layer 14 and an outer face of the second electrode layer 15 contacts the degradation prevention layer 16. Additionally, a through-hole is not formed on the first electrode layer 12 but a through-hole is formed on the second electrode layer 15, similarly to the eighth embodiment.

The protective layer 37 is formed on the supporter 11 so as to cover a side face of the first electrode layer 12, a side face of the electrochromic layer 13, a side face of the insulative porous layer 14, a side face of the second electrode layer 15, and a side face and a top face of the degradation prevention layer 16. It may be possible to form the protective layer 37 by, for example, applying onto the supporter 11 and subsequently curing an ultraviolet ray curable or thermosetting insulative resin or the like so as to cover a side face of the first electrode layer 12, a side face of the electrochromic layer 13, a side face of the insulative porous layer 14, and a side face of the second electrode layer 15, snf a side face and a top face of the degradation prevention layer 16. It may be possible for a film thickness of the protective layer 37 to be, for example, about 0.5-10 μm.

Thus, it may be possible for an electrochromic device according to the tenth embodiment to further exert the following effect(s) in addition to an effect of the eighth embodiment. That is, it may be possible to protect a second electrode layer or the like from damage or an electrical hindrance by forming a protective layer. Furthermore, it may be possible to prevent leakage of an electrolyte and improve durability by forming a protective layer. It may be more preferable to provide a protective layer with an ultraviolet ray cutting function or an antistatic function.

### Eleventh Embodiment

An eleventh embodiment illustrates an electrochromic device with a layer structure different from that of the tenth embodiment. Additionally, a description(s) for a component identical to that of an already described embodiment may be omitted in the eleventh embodiment.

FIG. 11 is a cross-sectional diagram that illustrates an electrochromic device according to the eleventh embodiment. As referring to FIG. 11, an electrochromic device 40 according to the eleventh embodiment is different from the electrochromic device 30 according to the tenth embodiment (see FIG. 10) in that the insulative porous layer 14 is replaced with an insulative porous layer 44.

In the present embodiment, an inner face of the first electrode layer 12 contacts the electrochromic layer 13 and an outer face of the first electrode layer 12 contacts the supporter 11. Furthermore, an inner face of the second electrode layer 15 contacts the insulative porous layer 44 and an outer face of the second electrode layer 15 contacts the degradation prevention layer 16. Additionally, a through-hole is not formed on the first electrode layer 12 but a through-hole is formed on the second electrode layer 15, similarly to the tenth embodiment.

The insulative porous layer 44 is a layer that further contains a white color pigment particle in the insulative porous layer 14, and functions as a white color reflective layer. For a material of a white color pigment particle, it may be possible to use, for example, a titanium oxide, an aluminum oxide, a zinc oxide, a silica, a cesium oxide, an yttrium oxide, or the like.

Thus, it may be possible for an electrochromic device according to the eleventh embodiment to further exert the following effect(s) in addition to an effect of the tenth embodiment. That is, it may be possible to readily realize a reflection-type display element by containing a white color pigment particle in an insulative porous layer to function as a white color reflective layer.

### Twelfth Embodiment

A twelfth embodiment illustrates an electrochromic device with a layer structure different from that of the tenth embodiment. Additionally, a description(s) for a component identical to that of an already described embodiment may be omitted in the twelfth embodiment.

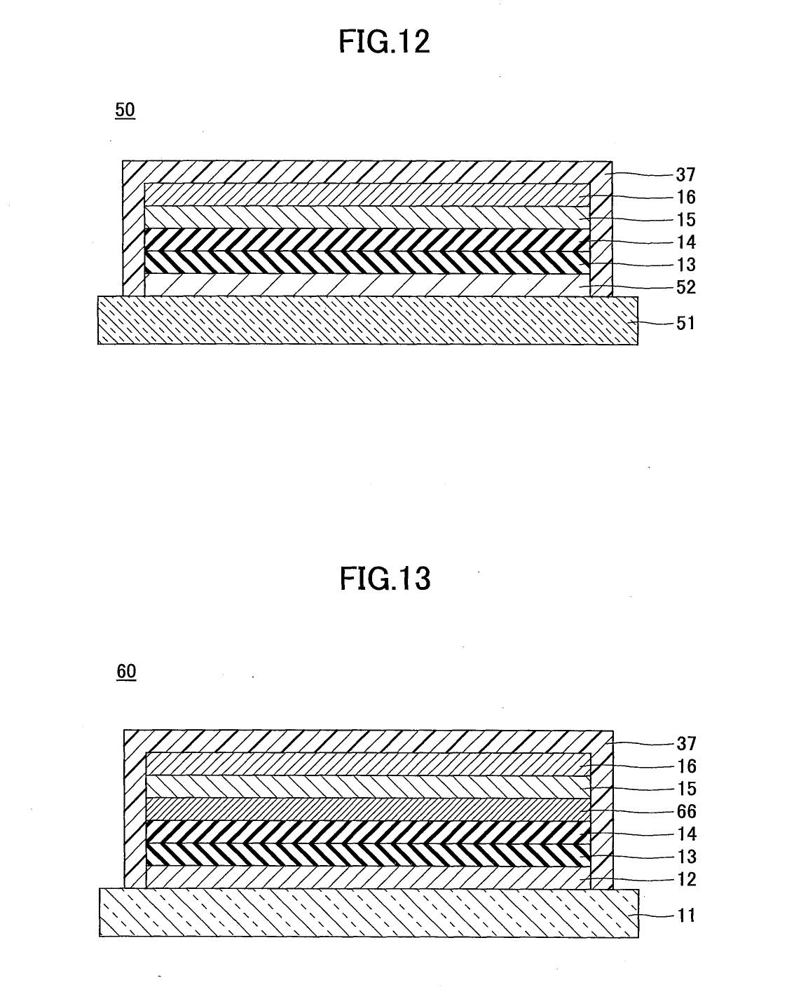

FIG. 12 is a cross-sectional diagram that illustrates an electrochromic device according to the twelfth embodiment. As referring to FIG. 12, an electrochromic device 50 according to the twelfth embodiment is different from the electrochromic device 30 according to the tenth embodiment (see FIG. 10) in that the supporter 11 and the first electrode layer 12 are replaced with a supporter 51 and a first electrode layer 52, respectively.

In the present embodiment, an inner face of the first electrode layer 52 contacts the electrochromic layer 13 and an outer face of the first electrode layer 52 contacts the supporter 51. Furthermore, an inner face of the second electrode layer 15 contacts the insulative porous layer 14 and an outer face of the second electrode layer 15 contacts the degradation prevention layer 16.

A through-hole is formed on the second electrode layer 15 similarly to the tenth embodiment. Furthermore, fine through-holes are formed on the supporter 51 and the first electrode layer 52, similarly to the second electrode layer 15. That is, the supporter 51 with a fine through-hole formed thereon is provided outside the first electrode layer 52 with a fine through-hole formed thereon.

Thus, it may be possible for an electrochromic device according to the twelfth embodiment to further exert the following effect(s) in addition to an effect of the tenth embodiment. That is, it may be possible to fill an insulative porous layer with an electrolyte from a side of a supporter through a first electrode layer and an electrochromic layer by forming fine through-holes on both the supporter and a first electrode layer formed on the supporter. As a result, it may be possible to form electrochromic devices on various sites, and it may be possible to further extend an applicability of an electrochromic device. Additionally, it may be possible to fill an insulative porous layer with an electrolyte from a gap in an electrochromic material that forms an electrochromic layer.

### Thirteenth Embodiment

A thirteenth embodiment illustrates an electrochromic device with a layer structure different from that of the tenth embodiment. Additionally, a description(s) for a component identical to that of an already described embodiment may be omitted in the thirteenth embodiment.

FIG. 13 is a cross-sectional diagram that illustrates an electrochromic device according to the thirteenth embodiment. As referring to FIG. 13, an electrochromic device 60 according to the thirteenth embodiment is different from the electrochromic device 30 according to the tenth embodiment (see FIG. 10) in that a degradation prevention layer 66 is added between the insulative porous layer 14 and the second electrode layer 15.

In the present embodiment, an inner face of the first electrode layer 12 contacts the electrochromic layer 13 and an outer face of the first electrode layer 12 contacts the supporter 11. Furthermore, an inner face of the second electrode layer 15 contacts the degradation prevention layer 66 and an outer face of the second electrode layer 15 contacts the degradation prevention layer 16. Additionally, a through-hole is not formed on the first electrode layer 12 but a through-hole is formed on the second electrode layer 15, similarly to the tenth embodiment.

As described above, although it may be preferable to form a degradation prevention layer as an overlying layer for a second electrode layer with a through-hole formed thereon (outside two opposing electrode layers), it may be possible to form a degradation prevention layer as an underlying layer for a second electrode layer (inside two opposing electrode layers) by selection of a material that composes a degradation prevention layer. In the present embodiment, the degradation prevention layer 66 is formed as an underlying layer for the second electrode layer 15 with a through-hole formed thereon; so that it may be necessary to select a material that may be difficult to be damaged for the degradation prevention layer 66. For one example of such a material, it may be possible to provide an electrically conductive or semi-conductive metal oxide that includes an antimony tin oxide, a nickel oxide, a titanium oxide, a zinc oxide, a tin oxide, or a plurality thereof, or the like.

Thus, it may be possible for an electrochromic device according to the thirteenth embodiment to further exert the following effect(s) in addition to an effect of the tenth embodiment. That is, a degradation prevention layer is formed between an insulative porous layer and a second electrode layer, so that it may be possible to realize an electrochromic device with more improved repetition stability.

### Fourteenth Embodiment

A fourteenth embodiment illustrates an electrochromic device with a layer structure different from that of the tenth embodiment. Additionally, a description(s) for a component identical to that of an already described embodiment may be omitted in the fourteenth embodiment.

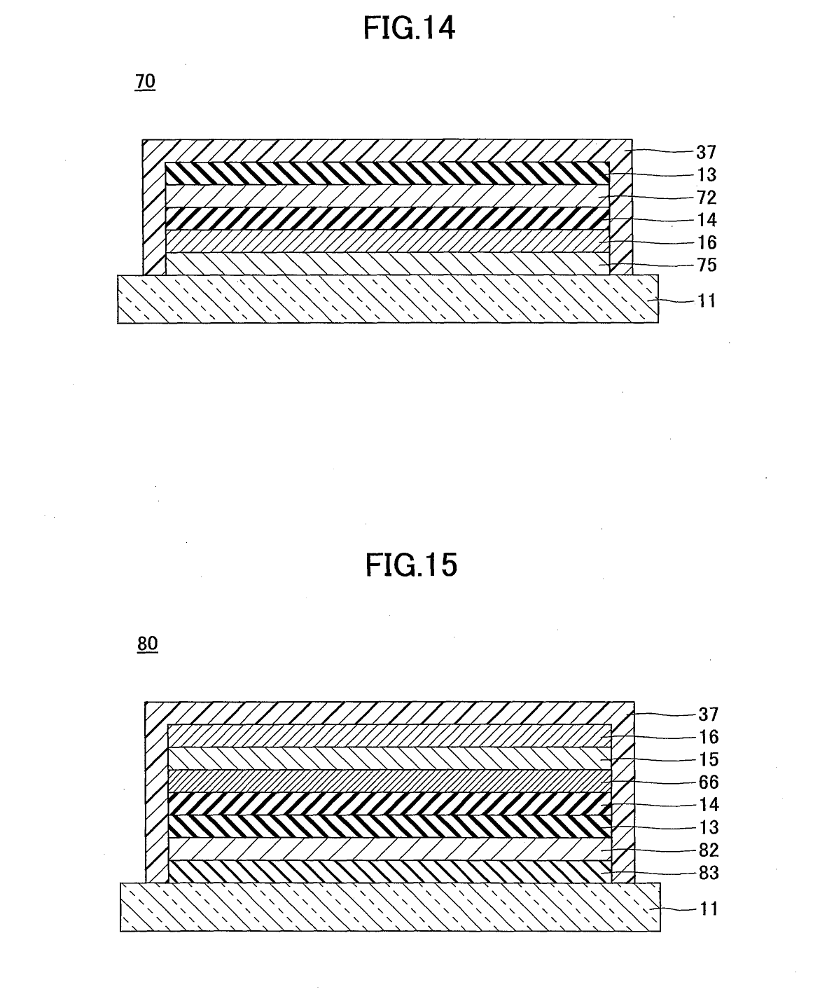

FIG. 14 is a cross-sectional diagram that illustrates an electrochromic device according to the fourteenth embodiment. As referring to FIG. 14, a layer structure on the supporter 11 in an electrochromic device 70 according to the fourteenth embodiment is different from that of the electrochromic device 30 according to the tenth embodiment (see FIG. 10). Specifically, a second electrode layer 75, the degradation prevention layer 16, the insulative porous layer 14, a first electrode layer 72, and the electrochromic layer 13 are sequentially laminated on the supporter 11 in the electrochromic device 70.

In the present embodiment, an inner face of the first electrode layer 72 contacts the insulative porous layer 14 and an outer face of the first electrode layer 72 contacts the electrochromic layer 13. Furthermore, an inner face of the second electrode layer 75 contacts the degradation prevention layer 16 and an outer face of the second electrode layer 75 contacts the supporter 11. Additionally, a through-hole is formed on the first electrode layer 72 similarly to the second electrode layer 15 in the tenth embodiment or the like but a through-hole is not formed on the second electrode layer 75, similarly to the first electrode layer 12 in the tenth embodiment or the like.

An electrolyte (not illustrated) is provided to fill between the first electrode layer 72 and the second electrode layer 75 and contact the degradation prevention layer 16, and to contact the electrochromic layer 13 via a through-hole formed on the first electrode layer 72.

Thus, it may be possible for an electrochromic device according to the fourteenth embodiment to further exert the following effect(s) in addition to an effect of the tenth embodiment. That is, it may be possible to suppress damage in a process for laminating an electrochromic layer. Conventionally, it has been necessary to form an electrochromic layer between two opposing electrode layers. However, a through-hole is formed on a first electrode layer in the present embodiment, so that it may be possible to form an electrochromic layer outside a first electrode layer (outside two opposing electrode layers) to contact the first electrode layer. This is because it may be possible for an ion to move between a front and a back of a first electrode layer through a through-hole formed on the first electrode layer.

Additionally, an electrochromic layer is provided as an overlying layer for a first electrode layer with a through-hole formed thereon, and accordingly, the reason why it may be possible to suppress damage to be applied to an electrochromic layer is similar to the reason why it may be possible to suppress damage to be applied to a degradation prevention layer in the eighth embodiment.

In the fourteenth embodiment, it may be possible for an electrochromic layer 13 to be composed of a porous thin film or a permeable thin film that may generally not inhibit injection of an electrolyte. In such a case, it may be desirable for a configuration of an electrochromic layer to contain a nanoparticle with a structure for carrying an organic electrochromic compound on an electrically conductive or semi-conductive fine particle, or the like. Moreover, when an electrochromic device is fabricated as an optical element such as a lens wherein a transparency thereof may be required, it may be preferable to use a p-type semi-conductive layer with a higher transparency for the degradation prevention layer 16. A specific example thereof may be an organic material having a nitroxyl radical (NO radical) or the like and it may be possible to provide 2,2,6,6-tetramethylpiperdine-N-oxyl (TEMPO) derivative, a polymer material from the derivative, or the like.

### Fifteenth Embodiment

A fifteenth embodiment illustrates an electrochromic device with a layer structure different from that of the thirteenth embodiment. Additionally, a description(s) for a component identical to that of an already described embodiment may be omitted in the fifteenth embodiment.

FIG. 15 is a cross-sectional diagram that illustrates an electrochromic device according to the fifteenth embodiment. As referring to FIG. 15, an electrochromic device 80 according to the fifteenth embodiment is different from the electrochromic device 60 according to the thirteenth embodiment (see FIG. 13) in that the first electrode layer 12 is replaced with a first electrode layer 82 and an electrochromic layer 83 is formed between the supporter 11 and the first electrode layer 82.

In the present embodiment, an inner face of the first electrode layer 82 contacts the electrochromic layer 13 and an outer face of the first electrode layer 82 contacts the electrochromic layer 83. Furthermore, an inner face of the second electrode layer 15 contacts the degradation prevention layer 66 and an outer face of the second electrode layer 15 contacts the degradation prevention layer 16. Additionally, a through-hole is formed on the first electrode layer 82 and a through-hole is also formed on the second electrode layer 15.

An electrolyte (not illustrated) is provided to fill between the first electrode layer 82 and the second electrode layer 15 and contact the electrochromic layer 13 and the degradation prevention layer 66, and to contact the electrochromic layer 83 via a through-hole formed on the first electrode layer 82 and contact the degradation prevention layer 16 via a through-hole formed on the second electrode layer 15. It may be possible for an ion to move between a front and a back of the first electrode layer 82 through a through-hole formed on the first electrode layer 82. Furthermore, it may be possible for an ion to move between a front and a back of the second electrode layer 15 through a through-hole formed on the second electrode layer 15.

Thus, it may be possible for an electrochromic device according to the fifteenth embodiment to further exert the following effect(s) in addition to an effect of the thirteenth embodiment. That is, an electrochromic layer is provided at both sides of a first electrode layer, so that it may be possible to increase a coloring density of an electrochromic layer.

### Sixteenth Embodiment

A sixteenth embodiment illustrates an electrochromic device with a layer structure different from that of the fourteenth embodiment. Additionally, a description(s) for a component identical to that of an already described embodiment may be omitted in the sixteenth embodiment.

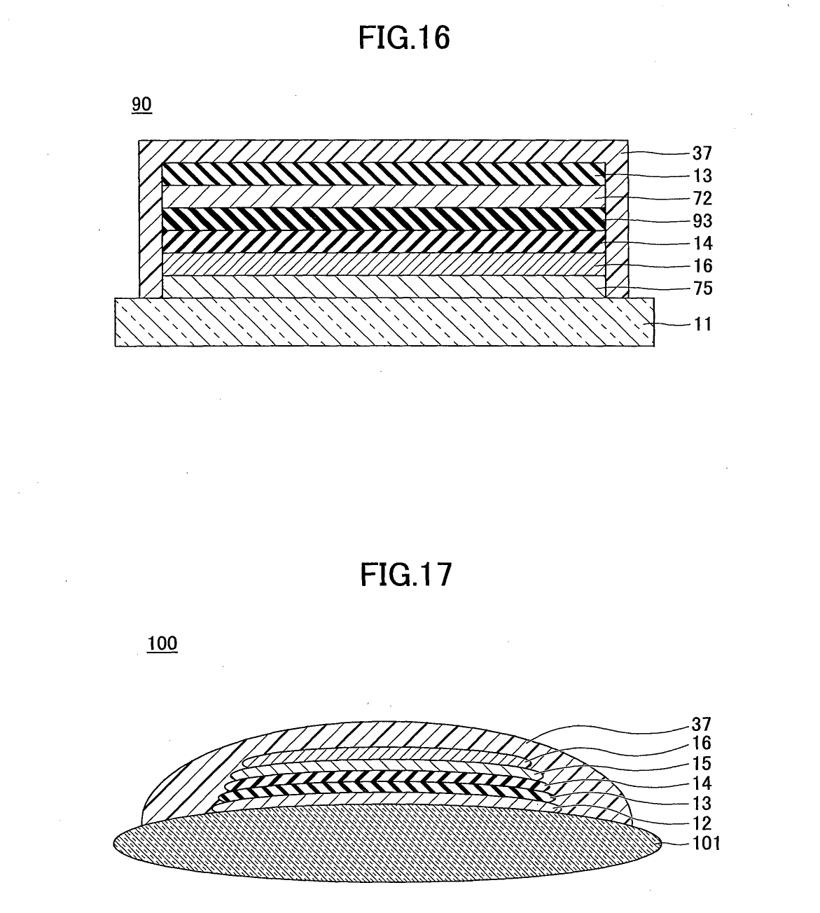

FIG. 16 is a cross-sectional diagram that illustrates an electrochromic device according to the sixteenth embodiment. As referring to FIG. 16, an electrochromic device 90 according to the sixteenth embodiment is different from the electrochromic device 70 according to the fourteenth embodiment (see FIG. 14) in that an electrochromic layer 93 is formed between the insulative porous layer 14 and the first electrode layer 72.

In the present embodiment, an inner face of the first electrode layer 72 contacts the electrochromic layer 93 and an outer face of the first electrode layer 72 contacts the electrochromic layer 13. Furthermore, an inner face of the second electrode layer 75 contacts the degradation prevention layer 16 and an outer face of the second electrode layer 75 contacts the supporter 11. Additionally, a through-hole is formed on the first electrode layer 72 similarly to the fourteenth embodiment and a through-hole is not formed on the second electrode layer 75 similarly to the fourteenth embodiment.

Similarly to a case of the degradation prevention layer described above, it may be preferable to form an electrochromic layer as an overlying layer for a first electrode layer with a through-hole formed thereon (outside two opposing electrode layers). However, it may be possible to form an electrochromic layer as an underlying layer for a first electrode layer (inside two opposing electrode layers) by selection of a material that composes an electrochromic layer. In the present embodiment, the electrochromic layer 93 is formed as an underlying layer for the first electrode layer 72 with a through-hole formed thereon, so that it may be preferable to select a material that may be difficult to be damaged for the electrochromic layer 93.

For such a material, it is considered that an inorganic electrochromic compound such as, for example, a tungsten oxide, a molybdenum oxide, an iridium oxide, or a titanium oxide may be preferable, and it may be possible to use an organic electrochromic compound depending on a design of a material and a process condition.

Thus, it may be possible for an electrochromic device according to the sixteenth embodiment to further exert the following effect(s) in addition to an effect of the fourteenth embodiment. That is, an electrochromic layer is provided at both sides of a second electrode layer, so that it may be possible to increase a coloring density of an electrochromic layer.

### Seventeenth Embodiment

A seventeenth embodiment illustrates an electrochromic device with each layer formed on a supporter different from those of the eighth to sixteenth embodiments. Additionally, a description(s) for a component identical to that of an already described embodiment may be omitted in the seventeenth embodiment.

FIG. 17 is a cross-sectional diagram that illustrates an electrochromic device according to the seventeenth embodiment. As referring to FIG. 17, an electrochromic device 100 according to the seventeenth embodiment is different from the electrochromic device 30 according to the tenth embodiment (see FIG. 10) in that the supporter 11 is replaced with a supporter 101.

In the present embodiment, an inner face of the first electrode layer 12 contacts the electrochromic layer 13 and an outer face of the first electrode layer 12 contacts the supporter 101. Furthermore, an inner face of the second electrode layer 15 contacts the insulative porous layer 14 and an outer face of the second electrode layer 15 contacts the degradation prevention layer 16. Additionally, a through-hole is not formed on the first electrode layer 12 but a through-hole is formed on the second electrode layer 15, similarly to the eighth embodiment.

The supporter 101 is an optical lens. A face that forms each layer of the supporter 101 is a curved face, so that it may be extremely difficult to form each layer in a conventional method of bonding two supporters while an electrolytic solution is interposed therebetween. On the other hand, in the present embodiment, it may be possible to laminate and form each layer by a manufacturing method that does not have an already described bonding process, similarly to a case where a layer formation face of a supporter is a plane face, even though a layer formation face of a supporter is a curved face. Additionally, the supporter 101 may be an eyeglass or the like.

Thus, it may be possible for an electrochromic device according to the seventeenth embodiment to further exert the following effect(s) in addition to an effect of the eighth embodiment. That is, it may be possible to use a supporter wherein a face for forming each layer is a curved face, so that it may be possible to select an optical element that has a curved face, such as an optical lens or an eyeglass, as a supporter. It may be possible to realize an electrochromic device capable of controlling light readily (an electrically light controllable optical device) by using an optical element such as an optical lens or an eyeglass.

### Practical Example 1

Practical Example 1 illustrates an example of fabricating the electrochromic device 30 illustrated in FIG. 3. Additionally, it is possible to use an electrochromic device fabricated in Practical Example 1 as a light control glass device.

(Formation of a First Electrode Layer and an Electrochromic Layer)

First, a 40 mm×40 mm glass substrate with a thickness of 0.7 mm was prepared as the supporter 11 and an ITO film with a thickness of about 100 nm was film-formed on a 20 mm×20 mm area and an extraction part on the glass substrate via a metal mask by a sputtering method, so that a first electrode layer 12 was formed.

Then, a titanium oxide nanoparticle dispersion fluid (commercial name: SP210, produced by SHOWA TITANIUM Company, average particle diameter: about 20 nm) was applied onto a surface of this ITO film by a spin-coating method and an anneal treatment was conducted at 120° C. for 15 minutes, so that a nano-structure semiconductor material composed of an about 1.0 μm titanium oxide particle film was formed.

Subsequently, after a solution that included 1.5 wt % of a compound represented by a structural formula [chem 2] of

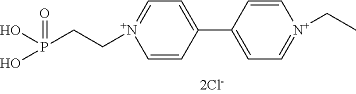 [SMILES: CC[n+]1ccc(-c2cc[n+](CCP(=O)(O)O)cc2)cc1]

as an electrochromic compound in 2,2,3,3-tetrafluoropropanol was applied by a spin-coating method, an anneal treatment was conducted at 120° C. for 10 minutes to be carried (adsorbed) on the titanium oxide particle film, so that the electrochromic layer 13 was formed.

(Formation of an Insulative Porous Layer and a Second Electrode Layer with a Fine Through-Hole Formed Thereon)

Subsequently, a SiO₂ fine particle dispersion fluid with an average primary particle diameter of 20 nm (concentration of silica solid content: 24.8 weight %, poly(vinyl alcohol): 1.2 weight %, and water: 74 weight %) was spin-coated onto the electrochromic layer 13, so that the insulative porous layer 14 was formed. A film thickness of the formed insulative porous layer 14 was about 2 Moreover, a SiO₂ fine particle dispersion fluid with an average primary particle diameter of 450 nm (concentration of a silica solid content: 1 weight % and 2-propanol: 99 weight %) was spin-coated, so that a mask for fine through-hole formation (colloidal mask) was formed.

Subsequently, an inorganic insulation layer of ZnS—SiO₂ (8/2) with a film thickness of 40 nm was formed on the mask for fine through-hole formation by a sputtering method. Moreover, an about 100 nm ITO film was formed on a 20 mm×20 mm area superposed on an ITO film formed as the first electrode layer 12 and an area different from the first electrode layer 12 on the inorganic insulation layer by a sputtering method via a metal mask, so that the second electrode layer 15 was fabricated. Additionally, an ITO film formed on an area different from the first electrode layer 12 was an extraction part of the second electrode layer 15.

Subsequently, ultrasonic wave irradiation in 2-propanol was conducted for 3 minutes to conduct a treatment for removing 450 nm SiO₂ fine particles as a colloidal mask. It was confirmed by SEM observation that the second electrode layer 15 with about 250 nm fine through-hole formed thereon was formed. A sheet resistance of the second electrode layer 15 was about 100Ω/□.

(Filling with an Electrolyte)

While an electrolytic solution was a solution provided by mixing tetrabutylammonium perchlorate as an electrolyte and dimethyl sulfoxide and poly(ethylene glycol) (molecular weight: 200) as solvents at 12:54:60, an element with the formed second electrode layer 15 with a fine through-hole formed thereon was dipped therein for 1 minute and subsequently dried on a hot plate at 120° C. for 1 minute to be filled with the electrolyte.

(Formation of a Protective Layer)

Moreover, an ultraviolet ray curing adhesive (commercial name: SD-17 produced by DIC CORPORATION) was spin-coated and cured by irradiation with ultraviolet rays, so that the protective layer 36 with a thickness of about 3 μm was formed. Thereby, the electrochromic device 30 as illustrated in FIG. 3 was obtained.

(Coloration or Discoloration Driving)

Coloration or discoloration of the fabricated electrochromic device 30 was confirmed. Specifically, as a voltage of −5V was applied between an extraction part of the first electrode layer 12 and an extraction part of the second electrode layer 15 for 3 seconds, coloration of a blue color originating from the electrochromic compound with a structural formula [chem 2] was confirmed at a superposing portion of the first electrode layer 12 and the second electrode layer 15.

Moreover, as a voltage of +5V was applied between an extraction part of the first electrode layer 12 and an extraction part of the second electrode layer 15 for 3 seconds, it was confirmed that a dye in a superposing portion of the first electrode layer 12 and the second electrode layer 15 was discolored to be transparent.

### Practical Example 2

Practical Example 2 illustrates an example of fabricating the electrochromic device 40 illustrated in FIG. 4. Additionally, it is possible to use an electrochromic device fabricated in Practical Example 2 as a reflection-type display device.

(Fabrication of an Electrochromic Device)

White color titanium oxide particles with an average particle diameter of 250 nm were added and mixed into a SiO₂ fine particle dispersion fluid at 50 wt % with respect to silica particles, so that the insulative porous layer 44 (white color reflection layer) was formed. Otherwise, the electrochromic device 40 illustrated in FIG. 4 was obtained similarly to Practical Example 1.

(Coloration or Discoloration Driving)

Coloration or discoloration of the fabricated electrochromic device 40 was confirmed. Specifically, as a voltage of −5V was applied between an extraction part of the first electrode layer 12 and an extraction part of the second electrode layer 15 for 3 seconds, coloration of a blue color originating from the electrochromic compound with a structural formula [chem 2] was confirmed at a superposing portion of the first electrode layer 12 and the second electrode layer 15.

Moreover, as a voltage of +5V was applied between an extraction part of the first electrode layer 12 and an extraction part of the second electrode layer 15 for 3 seconds, it was confirmed that a dye in a superposing portion of the first electrode layer 12 and the second electrode layer 15 was discolored to be a white color.

### Practical Example 3

Practical Example 3 illustrates another example of fabricating the electrochromic device 30 illustrated in FIG. 3. Additionally, it is possible to use an electrochromic device fabricated in Practical Example 3 as a light control glass device.

(Fabrication of an Electrochromic Device)

An electrolytic solution was a solution provided by mixing lithium perchlorate as an electrolyte, poly(ethylene glycol) (molecular weight: 200) and propylene carbonate as solvents, and an urethane adhesive (commercial name: 3301 produced by Henkel Japan Ltd.) as an ultraviolet ray curing material at 1.4:6:8:10, then spin-coated onto a surface of the second electrode layer 15 with a fine through-hole formed thereon, and subsequently dried on a hot plate at 120° C. for 1 minute to be filled with the electrolyte.

Moreover, an ultraviolet ray curing adhesive (commercial name: NOPCO 134 produced by SAN NOPCO LIMITED) was spin-coated and cured by irradiation with ultraviolet rays, so that the protective layer 36 with a thickness of about 3 μm was formed. Otherwise, the electrochromic device 30 illustrated in FIG. 3 was obtained similarly to Practical Example 1.

(Coloration or Discoloration Driving)

Coloration or discoloration of the fabricated electrochromic device 30 was confirmed. Specifically, as a voltage of −5V was applied between an extraction part of the first electrode layer 12 and an extraction part of the second electrode layer 15 for 3 seconds, coloration of a blue color originating from the electrochromic compound with a structural formula [chem 2] was confirmed at a superposing portion of the first electrode layer 12 and the second electrode layer 15.

Moreover, as a voltage of +5V was applied between an extraction part of the first electrode layer 12 and an extraction part of the second electrode layer 15 for 3 seconds, it was confirmed that a dye in a superposing portion of the first electrode layer 12 and the second electrode layer 15 was discolored to be transparent.

### Practical Example 4

Practical Example 4 illustrates an example of fabricating the electrochromic device 50 illustrated in FIG. 5. Additionally, it is possible to use an electrochromic device fabricated in Practical Example 4 as a light control film.

(Fabrication of an Electrochromic Device)

A poly(ethylene) porous film (commercial name: SUNMAP LC produced by NITTO DENKO CORPORATION, average pore diameter: 17 μm, porosity: 30%) was used as the supporter 51 to form the first electrode layer 52 with a through-hole formed thereon, on the supporter 51, similarly to the second electrode layer 15 of Practical Example 1. Furthermore, an inorganic insulative layer of ZnS—SiO₂ (8/2) and the second electrode layer 55 of ITO were directly formed on the insulative porous layer 14 (A colloidal lithography was not used. That is, a through-hole was not formed.). Otherwise, the electrochromic device 50 illustrated in FIG. 5 was obtained similarly to Practical Example 1.

(Coloration or Discoloration Driving)

Coloration or discoloration of the fabricated electrochromic device 50 was confirmed. Specifically, as a voltage of −5V was applied between an extraction part of the first electrode layer 52 and an extraction part of the second electrode layer 55 for 3 seconds, coloration of a blue color originating from the electrochromic compound with a structural formula [chem 2] was confirmed at a superposing portion of the first electrode layer 52 and the second electrode layer 55.

Moreover, as a voltage of +5V was applied between an extraction part of the first electrode layer 52 and an extraction part of the second electrode layer 55 for 3 seconds, it was confirmed that a dye in a superposing portion of the first electrode layer 52 and the second electrode layer 55 was discolored to be transparent.

### Practical Example 5

Practical Example 5 illustrates another example of fabricating the electrochromic device 30 illustrated in FIG. 3. Additionally, it is possible to use an electrochromic device fabricated in Practical Example 5 as a light control glass device.

(Fabrication of an Electrochromic Device)

An inorganic insulative layer of ZnS—SiO₂ (8/2) and the second electrode layer 15 of ITO were directly formed on the insulative porous layer 14 (A colloidal lithography was not used.). Furthermore, an electrolyte was changed to a single body of ethylmethylimidazolinium salt that was an ionic liquid, then dropped onto the second electrode layer 15, and subsequently heated on a hot plate at 120° C. for 10 minutes to be filled with the electrolyte. Otherwise, the electrochromic device 30 illustrated in FIG. 3 was obtained similarly to Practical Example 1.

(Coloration or Discoloration Driving)

Coloration or discoloration of the fabricated electrochromic device 30 was confirmed. Specifically, as a voltage of −5V was applied between an extraction part of the first electrode layer 12 and an extraction part of the second electrode layer 15 for 3 seconds, coloration of a blue color originating from the electrochromic compound with a structural formula [chem 2] was confirmed at a superposing portion of the first electrode layer 12 and the second electrode layer 15.

Moreover, as a voltage of +5V was applied between an extraction part of the first electrode layer 12 and an extraction part of the second electrode layer 15 for 3 seconds, it was confirmed that a dye in a superposing portion of the first electrode layer 12 and the second electrode layer 15 was discolored to be transparent.

### Practical Example 6

Practical Example 6 illustrates an example of fabricating the electrochromic device 30 illustrated in FIG. 10. Additionally, it is possible to use an electrochromic device fabricated in Practical Example 6 as a light control glass device.

(Formation of a First Electrode Layer and an Electrochromic Layer)

First, a 40 mm×40 mm glass substrate with a thickness of 0.7 mm was prepared as the supporter 11 and an ITO film with a thickness of about 100 nm was film-formed on a 20 mm×20 mm area and an extraction part on the glass substrate via a metal mask by a sputtering method, so that a first electrode layer 12 was formed.

Then, a titanium oxide nanoparticle dispersion fluid (commercial name: SP210, produced by SHOWA TITANIUM Company, average particle diameter: about 20 nm) was applied onto a surface of this ITO film by a spin-coating method and an anneal treatment was conducted at 120° C. for 15 minutes, so that a nano-structure semiconductor material composed of an about 1.0 μm titanium oxide particle film was formed. Subsequently, after a solution that included 1.5 wt % of a compound represented by a structural formula [chem 2] of

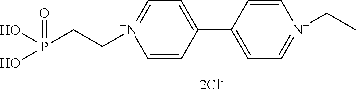 [SMILES: CC[n+]1ccc(-c2cc[n+](CCP(=O)(O)O)cc2)cc1]

as an electrochromic compound in 2,2,3,3-tetrafluoropropanol was applied by a spin-coating method, an anneal treatment was conducted at 120° C. for 10 minutes to be carried (adsorbed) on the titanium-oxide particle film, so that the electrochromic layer 13 was formed.

(Formation of an Insulative Porous Layer and a Second Electrode Layer with a Fine Through-Hole Formed Thereon)

Subsequently, a SiO₂ fine particle dispersion fluid with an average primary particle diameter of 20 nm (concentration of silica solid content: 24.8 weight %, poly(vinyl alcohol): 1.2 weight %, and water: 74 weight %) was spin-coated onto the electrochromic layer 13, so that the insulative porous layer 14 was formed. A film thickness of the formed insulative porous layer 14 was about 2 Moreover, a SiO₂ fine particle dispersion fluid with an average primary particle diameter of 450 nm (concentration of a silica solid content: 1 weight % and 2-propanol: 99 weight %) was spin-coated, so that a mask for fine through-hole formation (colloidal mask) was formed.

Subsequently, an inorganic insulation layer of ZnS—SiO₂ (8/2) with a film thickness of 40 nm was formed on the mask for fine through-hole formation by a sputtering method. Moreover, an about 100 nm ITO film was formed on a 20 mm×20 mm area superposed on an ITO film formed as the first electrode layer 12 and an area different from the first electrode layer 12 on the inorganic insulation layer by a sputtering method via a metal mask, so that the second electrode layer 15 was fabricated. Additionally, an ITO film formed on an area different from the first electrode layer 12 was an extraction part of the second electrode layer 15.

Subsequently, ultrasonic wave irradiation in 2-propanol was conducted for 3 minutes to conduct a treatment for removing 450 nm SiO₂ fine particles as a colloidal mask. It was confirmed by SEM observation that the second electrode layer 15 with about 250 nm fine through-hole formed thereon was formed. A sheet resistance of the second electrode layer 15 was about 100Ω/□.

(Formation of a Degradation Prevention Layer)

Subsequently, a titanium oxide nanoparticle dispersion fluid (commercial name: SP210, produced by SHOWA TITANIUM Company, average particle diameter: about 20 nm) was applied onto the second electrode layer 15 by a spin-coating method as the degradation prevention layer 16, and an anneal treatment was conducted at 120° C. for 15 minutes, so that a nano-structure semiconductor material composed of an about 1.0 μm titanium oxide particle film was formed.

(Filling with an Electrolyte)

While an electrolytic solution was a solution provided by mixing tetrabutylammonium perchlorate as an electrolyte and dimethyl sulfoxide and poly(ethylene glycol) (molecular weight: 200) as solvents at 12:54:60, an element with the degradation prevention layer 16 formed thereon was dipped therein for 1 minute and subsequently dried on a hot plate at 120° C. for 1 minute to be filled with the electrolyte.

(Formation of a Protective Layer)

Moreover, an ultraviolet ray curing adhesive (commercial name: SD-17 produced by DIC CORPORATION) was spin-coated and cured by irradiation with ultraviolet rays, so that the protective layer 37 with a thickness of about 3 μm was formed. Thereby, the electrochromic device 30 as illustrated in FIG. 10 was obtained.

(Coloration or Discoloration Driving)

Coloration or discoloration of the fabricated electrochromic device 30 was confirmed. Specifically, as a voltage of −4V was applied between an extraction part of the first electrode layer 12 and an extraction part of the second electrode layer 15 for 3 seconds, coloration of a blue color originating from the electrochromic compound with a structural formula [chem 2] was confirmed at a superposing portion of the first electrode layer 12 and the second electrode layer 15.

Moreover, as a voltage of +4V was applied between an extraction part of the first electrode layer 12 and an extraction part of the second electrode layer 15 for 3 seconds, it was confirmed that a dye in a superposing portion of the first electrode layer 12 and the second electrode layer 15 was discolored to be transparent.

### Practical Example 7

Practical Example 7 illustrates an example of fabricating the electrochromic device 40 illustrated in FIG. 11. Additionally, it is possible to use an electrochromic device fabricated in Practical Example 7 as a reflection-type display device.

(Fabrication of an Electrochromic Device)

White color titanium oxide particles with an average particle diameter of 250 nm were added and mixed into a SiO₂ fine particle dispersion fluid at 50 wt % with respect to silica particles, so that the insulative porous layer 44 (white color reflection layer) was formed. Otherwise, the electrochromic device 40 illustrated in FIG. 11 was obtained similarly to Practical Example 6.

(Coloration or Discoloration Driving)

Coloration or discoloration of the fabricated electrochromic device 40 was confirmed. Specifically, as a voltage of −4V was applied between an extraction part of the first electrode layer 12 and an extraction part of the second electrode layer 15 for 3 seconds, coloration of a blue color originating from the electrochromic compound with a structural formula [chem 2] was confirmed at a superposing portion of the first electrode layer 12 and the second electrode layer 15.

Moreover, as a voltage of +4V was applied between an extraction part of the first electrode layer 12 and an extraction part of the second electrode layer 15 for 3 seconds, it was confirmed that a dye in a superposing portion of the first electrode layer 12 and the second electrode layer 15 was discolored to be a white color.

### Practical Example 8

Practical Example 8 illustrates another example of fabricating the electrochromic device 30 illustrated in FIG. 10. Additionally, it is possible to use an electrochromic device fabricated in Practical Example 8 as a light control glass device.

(Fabrication of an Electrochromic Device)

An electrolytic solution was a solution provided by mixing lithium perchlorate as an electrolyte, poly(ethylene glycol) (molecular weight: 200) and propylene carbonate as solvents, and an urethane adhesive (commercial name: 3301 produced by Henkel Japan Ltd.) as an ultraviolet ray curing material at 1.4:6:8:10, then spin-coated onto a surface of the second electrode layer 15 with a fine through-hole formed thereon, and subsequently dried on a hot plate at 120° C. for 1 minute to be filled with the electrolyte.

Moreover, an ultraviolet ray curing adhesive (commercial name: NOPCO 134 produced by SAN NOPCO LIMITED) was spin-coated and cured by irradiation with ultraviolet rays, so that the protective layer 37 with a thickness of about 3 μm was formed. Otherwise, the electrochromic device 30 illustrated in FIG. 10 was obtained similarly to Practical Example 6.

(Coloration or Discoloration Driving)

Coloration or discoloration of the fabricated electrochromic device 30 was confirmed. Specifically, as a voltage of −4V was applied between an extraction part of the first electrode layer 12 and an extraction part of the second electrode layer 15 for 3 seconds, coloration of a blue color originating from the electrochromic compound with a structural formula [chem 2] was confirmed at a superposing portion of the first electrode layer 12 and the second electrode layer 15.

Moreover, as a voltage of +4V was applied between an extraction part of the first electrode layer 12 and an extraction part of the second electrode layer 15 for 3 seconds, it was confirmed that a dye in a superposing portion of the first electrode layer 12 and the second electrode layer 15 was discolored to be transparent.

### Practical Example 9

Practical Example 9 illustrates an example of fabricating the electrochromic device 50 illustrated in FIG. 12. Additionally, it is possible to use an electrochromic device fabricated in Practical Example 9 as a light control film.

(Fabrication of an Electrochromic Device)

A poly(ethylene) porous film (commercial name: SUNMAP LC produced by NITTO DENKO CORPORATION, average pore diameter: 17 μm, porosity: 30%) was used as the supporter 51 to form the first electrode layer 52 with a through-hole formed thereon, on the supporter 51, similarly to the second electrode layer 15 of Practical Example 6. Otherwise, the electrochromic device 50 illustrated in FIG. 12 was obtained similarly to Practical Example 6.

(Coloration or Discoloration Driving)

Coloration or discoloration of the fabricated electrochromic device 50 was confirmed. Specifically, as a voltage of −5V was applied between an extraction part of the first electrode layer 52 and an extraction part of the second electrode layer 15 for 3 seconds, coloration of a blue color originating from the electrochromic compound with a structural formula [chem 2] was confirmed at a superposing portion of the first electrode layer 52 and the second electrode layer 15.

Moreover, as a voltage of +5V was applied between an extraction part of the first electrode layer 52 and an extraction part of the second electrode layer 15 for 3 seconds, it was confirmed that a dye in a superposing portion of the first electrode layer 52 and the second electrode layer 15 was discolored to be transparent.

### Practical Example 10

Practical Example 10 illustrates an example of fabricating the electrochromic device 70 illustrated in FIG. 14. Additionally, it is possible to use an electrochromic device fabricated in Practical Example 10 as a light control glass device.

(Formation of an Electrochromic Device)

An ITO film with a thickness of about 100 nm was film-formed on the supporter 11 via a metal mask by a sputtering method, so that the second electrode layer 75 was formed. Subsequently, a titanium oxide nanoparticle dispersion fluid (commercial name: SP210, produced by SHOWA TITANIUM Company, average particle diameter: about 20 nm) was applied as the degradation prevention layer 16 by a spin-coating method and an anneal treatment was conducted at 120° C. for 15 minutes, so that a nano-structure semiconductor material composed of an about 1.0 μm titanium oxide particle film was formed.

Subsequently, the insulative porous layer 14 was formed similarly to Practical Example 6. Moreover, a SiO₂ fine particle dispersion fluid with an average primary particle diameter of 450 nm (concentration of a silica solid content: 1 weight % and 2-propanol: 99 weight %) was spin-coated, so that a mask for fine through-hole formation (colloidal mask) was formed.

Subsequently, an inorganic insulation layer of ZnS—SiO₂ (8/2) with a film thickness of 40 nm was formed on the mask for fine through-hole formation by a sputtering method. Moreover, an about 100 nm ITO film was formed on a 20 mm×20 mm area superposed on an ITO film formed as the second electrode layer 75 and an area different from the second electrode layer 75 on the inorganic insulation layer by a sputtering method via a metal mask, so that the first electrode layer 72 was fabricated. Subsequently, ultrasonic wave irradiation in 2-propanol was conducted for 3 minutes to conduct a treatment for removing 450 nm SiO₂ fine particles as a colloidal mask. A sheet resistance thereof was about 100Ω/□.

Subsequently, the electrochromic layer 13 was formed similarly to Practical Example 6. Subsequently, filling with an electrolyte was conducted similarly to Practical Example 8. Moreover, an ultraviolet ray curing adhesive (commercial name: NOPCO 134 produced by SAN NOPCO LIMITED) was spin-coated and cured by irradiation with ultraviolet rays, so that the protective layer 37 with a thickness of about 3 μm was formed.

(Coloration or Discoloration Driving)

Coloration or discoloration of the fabricated electrochromic device 70 was confirmed. Specifically, as a voltage of −5V was applied between an extraction part of the first electrode layer 72 and an extraction part of the second electrode layer 75 for 3 seconds, coloration of a blue color originating from the electrochromic compound with a structural formula [chem 2] was confirmed at a superposing portion of the first electrode layer 72 and the second electrode layer 75.

Moreover, as a voltage of +5V was applied between an extraction part of the first electrode layer 72 and an extraction part of the second electrode layer 75 for 3 seconds, it was confirmed that a dye in a superposing portion of the first electrode layer 72 and the second electrode layer 75 was discolored to be transparent.

### Practical Example 11

Practical Example 11 illustrates another example of fabricating the electrochromic device 30 illustrated in FIG. 10. Additionally, it is possible to use an electrochromic device fabricated in Practical Example 11 as a light control glass device.

(Fabrication of an Electrochromic Device)

A solution that included 2.5 wt % of a compound represented by a structural formula [chem 3] of

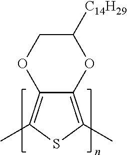

(average molecular weight: 10000) in tetrahydrofuran was applied onto a surface of an ITO film by a spin-coating method.

Subsequently, an anneal treatment was conducted at 120° C. for 10 minutes, so that the electrochromic layer 13 composed of an organic polymer material was formed. Additionally, the electrochromic layer exhibited a magenta color. Otherwise, the electrochromic device 30 illustrated in FIG. 10 was obtained similarly to Practical Example 8.

(Coloration or Discoloration Driving)

Coloration or discoloration of the fabricated electrochromic device 30 was confirmed. Specifically, as a voltage of +3V was applied between an extraction part of the first electrode layer 12 and an extraction part of the second electrode layer 15 for 3 seconds, it was confirmed that a dye in a superposing portion of the first electrode layer 12 and the second electrode layer 15 was discolored to be transparent.

Moreover, as a voltage of −3V was applied between an extraction part of the first electrode layer 12 and an extraction part of the second electrode layer 15 for 3 seconds, it was confirmed that a dye in a superposing portion of the first electrode layer 12 and the second electrode layer 15 was colored to be a magenta color and return to an initial state thereof.

### Comparative Example

An electrochromic device for comparison (referred to as an electrochromic device 30x) was obtained similarly to Practical Example 11 except that a degradation prevention layer was not formed.

(Coloration or Discoloration Driving)

Coloration or discoloration of the fabricated electrochromic device 30x was confirmed. As a voltage of +3V was applied between an extraction part of the first electrode layer 12 and an extraction part of the second electrode layer 15 for 3 seconds, a dye in a superposing portion of the first electrode layer 12 and the second electrode layer 15 was not discolored. Then, as an applied voltage was +6V, it was confirmed that discoloration was caused to be transparent.

Moreover, as a voltage of −6V was applied between an extraction part of the first electrode layer 12 and an extraction part of the second electrode layer 15 for 3 seconds, it was confirmed that a dye in a superposing portion of the first electrode layer 12 and the second electrode layer 15 was colored to be a magenta color and return to an initial state thereof.

Thus, a result was that a driving voltage in the comparative example was higher than that of Practical Example 11. In other words, it was confirmed that a driving voltage of the electrochromic device according to Practical Example 11 could be further reduced than the electrochromic device according to the comparative example. That is, an n-type semi-conductive metal oxide with a higher transparency (titanium oxide particle film) is used as the degradation prevention layer 16 and an organic polymer material that changes a colored state to a transparent state due to an oxidation reaction is used as the electrochromic layer 13, like Practical Example 11, so that it may be possible to reduce a driving voltage. This may be because the electrochromic layer 13 may be subjected to oxidation reaction and an n-type semi-conductive metal oxide that composes the degradation prevention layer 16 may readily be reduced (subjected to electron injection) simultaneously.

Although preferred embodiments and practical examples have been described above in detail, it is possible to apply various modifications and substitutions to the embodiments and practical examples described above without being limited to the embodiments and practical examples described above or departing from the scope recited in what is claimed. For example, it is possible to combine the respective embodiments described above appropriately.

### APPENDIX

### An Illustrative Embodiment(s) of an Electrochromic Device and a Manufacturing Method Thereof

At least one illustrative embodiment of the present invention may relate to at least one of an electrochromic device and a manufacturing method thereof.

An object of at least one illustrative embodiment of the present invention may to provide at least one of an electrochromic device capable of being fabricated without a bonding process and a manufacturing method thereof.

At least one illustrative embodiment of the present invention may be an electrochromic device that has a first electrode layer, a second electrode layer provided to oppose the first electrode layer, an electrochromic layer provided between the first electrode layer and the second electrode layer, and an electrolyte filling a predetermined region between the first electrode layer and the second electrode layer, wherein a through-hole is formed on at least one layer of the first electrode layer or the second electrode layer and wherein a supporter is provided on only either one side of an outside of the first electrode layer and an outside of the second electrode layer.

At least one illustrative embodiment of the present invention may be an electrochromic device that has a first electrode layer, a second electrode layer provided to oppose the first electrode layer, an electrochromic layer provided to contact the first electrode layer, a degradation prevention layer provided to contact the second electrode layer to prevent degradation of the second electrode layer, and an electrolyte filling between the first electrode layer and the second electrode layer and provided to contact the electrochromic layer and the degradation prevention layer, wherein each of the first electrode layer and the second electrode layer is provided with inner faces being mutually opposing faces and outer faces being faces at opposite sides of the inner faces, wherein a through-hole is formed on at least one electrode layer of the first electrode layer or the second electrode layer, wherein the electrochromic layer or the degradation prevention layer provided on the electrode layer with the through-hole formed thereon is provided on the outer face of the electrode layer with the through-hole formed thereon, and wherein a supporter is provided at only a side of the outer face of either one of the first electrode layer and the second electrode layer.

Illustrative Embodiment (1) is an electrochromic device that has a first electrode layer, a second electrode layer provided to oppose the first electrode layer, an electrochromic layer provided between the first electrode layer and the second electrode layer, and an electrolyte filling a predetermined region between the first electrode layer and the second electrode layer, wherein a through-hole is formed on at least one layer of the first electrode layer or the second electrode layer and wherein a supporter is provided at only either one side of an outside of the first electrode layer and an outside of the second electrode layer.

Illustrative Embodiment (2) is the electrochromic device as described in Illustrative Embodiment (1), wherein the through-hole is an injection hole for filling with the electrolyte or the electrolyte and an electrochromic material.

Illustrative Embodiment (3) is the electrochromic device as described in Illustrative Embodiment (1) or (2), wherein the supporter is provided outside a layer with a through-hole formed thereon among the first electrode layer or the second electrode layer and wherein a through-hole is formed on the supporter.

Illustrative Embodiment (4) is the electrochromic device as described in any one of Illustrative Embodiments (1) to (3), wherein a diameter of the through-hole is greater than or equal to 10 nm and less than or equal to 100 μm.

Illustrative Embodiment (5) is the electrochromic device as described in any one of Illustrative Embodiments (1) to (4), wherein an insulative porous layer for insulating the first electrode layer and the second electrode layer is provided between the first electrode layer and the second electrode layer and wherein the insulative porous layer includes an insulative metal oxide fine particle.

Illustrative Embodiment (6) is the electrochromic device as described in any one of Illustrative Embodiments (1) to (5), wherein the supporter is an optical element.

Illustrative Embodiment (7) is a method for manufacturing an electrochromic device that has a step of laminating a first electrode layer and an electrochromic layer on a supporter sequentially, a step of laminating a second electrode layer with a through-hole formed thereon via an insulative porous layer on the electrochromic layer to oppose the first electrode layer, and a step of filling a predetermined region between the first electrode layer and the second electrode layer with an electrolyte from the through-hole.

Illustrative Embodiment (8) is a method for manufacturing an electrochromic device that has a step of laminating a first electrode layer on a supporter, a step of laminating a second electrode layer with a through-hole formed thereon via an insulative porous layer on the first electrode layer to oppose the first electrode layer, and a step of filling a predetermined region between the first electrode layer and the second electrode layer with an electrolyte and an electrochromic material from the through-hole.

Illustrative Embodiment (9) is the method for manufacturing an electrochromic device as described in Illustrative Embodiment (7) or (8), wherein the step of laminating the second electrode layer includes a step of distributing a fine particle on an underlying layer to be laminated with the second electrode layer, a step of forming an electrically conductive film on a face with the fine particle distributed thereon by a vacuum film formation method, and a step of removing the electrically conductive film together with the fine particle.

Illustrative Embodiment (10) is the method for manufacturing an electrochromic device as described in Illustrative Embodiment (9), wherein a diameter of the fine particle is greater than or equal to a film thickness of the second electrode layer.

Illustrative Embodiment (11) is an electrochromic device that has a first electrode layer, a second electrode layer provided to oppose the first electrode layer, an electrochromic layer provided to contact the first electrode layer, a degradation prevention layer provided to contact the second electrode layer to prevent degradation of the second electrode layer, and an electrolyte filling between the first electrode layer and the second electrode layer and provided to contact the electrochromic layer and the degradation prevention layer, wherein each of the first electrode layer and the second electrode layer is provided with inner faces being mutually opposing faces and outer faces being faces at opposite sides of the inner faces, wherein a through-hole is formed on at least one electrode layer of the first electrode layer or the second electrode layer, wherein the electrochromic layer or the degradation prevention layer provided on the electrode layer with the through-hole formed thereon is provided on the outer face of the electrode layer with the through-hole formed thereon, and wherein a supporter is provided at only a side of the outer face of either one of the first electrode layer and the second electrode layer.

Illustrative Embodiment (12) is the electrochromic device as described in Illustrative Embodiment (11), wherein the electrochromic layer or the degradation prevention layer on the electrode layer with the through-hole formed thereon is also provided on the inner face of the electrode layer with the through-hole formed thereon.

Illustrative Embodiment (13) is the electrochromic device as described in Illustrative Embodiment (11) or (12), wherein the through-hole is an injection hole for filling with the electrolyte or the electrolyte and the electrochromic material.

Illustrative Embodiment (14) is the electrochromic device as described in any one of Illustrative Embodiments (11) to (13), wherein the supporter is provided at only a side of the outer face of the electrode layer with the through-hole formed thereon and wherein a through-hole is formed on the supporter.

Illustrative Embodiment (15) is the electrochromic device as described in any one of Illustrative Embodiments (11) to (14), wherein a diameter of the through-hole is greater than or equal to 10 nm and less than or equal to 100 μm.

Illustrative Embodiment (16) is the electrochromic device as described in any one of Illustrative Embodiments (11) to (15), wherein an insulative porous layer for insulating the first electrode layer and the second electrode layer is provided between the first electrode layer and the second electrode layer and wherein the insulative porous layer includes an insulative metal oxide fine particle.

Illustrative Embodiment (17) is the electrochromic device as described in any one of Illustrative Embodiments (11) to (16), wherein the degradation prevention layer includes a semiconductive metal oxide fine particle.

Illustrative Embodiment (18) is the electrochromic device as described in any one of Illustrative Embodiments (11) to (17), wherein the electrochromic layer is of a material that changes from being colored to being transparent due to an oxidation reaction and the degradation prevention layer includes a transparent n-type semiconductive oxide particle.

Illustrative Embodiment (19) is the electrochromic device as described in any one of Illustrative Embodiments (11) to (18), wherein the supporter is an optical element.

Illustrative Embodiment (20) is a method for manufacturing an electrochromic device that has a step of laminating a first electrode layer and an electrochromic layer on a supporter sequentially, a step of laminating a second electrode layer with a through-hole formed thereon on the electrochromic layer to oppose the first electrode layer, a step of providing a degradation prevention layer to contact a face of the second electrode layer at an opposite side of a face opposing the first electrode layer, and a step of filling a predetermined region between the first electrode layer and the second electrode layer with an electrolyte from the through-hole via the degradation prevention layer.

Illustrative Embodiment (21) is a method for manufacturing an electrochromic device that has a step of laminating a second electrode layer and a degradation prevention layer on a supporter sequentially, a step of laminating a first electrode layer with a through-hole formed thereon on the degradation prevention layer to oppose the second electrode layer, a step of providing an electrochromic layer to contact a face of the first electrode layer at an opposite side of a face opposing the second electrode layer, and a step of filling a predetermined region between the first electrode layer and the second electrode layer with an electrolyte from the through-hole via the electrochromic layer.

Illustrative Embodiment (22) is the method for manufacturing an electrochromic device as described in Illustrative Embodiment (20) or (21), wherein the step of laminating the electrode layer with a through-hole formed thereon includes a step of distributing a fine particle on an underlying layer to be laminated with the electrode layer with a through-hole formed thereon, a step of forming an electrically conductive film on a face with the fine particle distributed thereon by a vacuum film formation method, and a step of removing the electrically conductive film together with the fine particle.

Illustrative Embodiment (23) is the method for manufacturing an electrochromic device as described in Illustrative Embodiment (22), wherein a diameter of the fine particle is greater than or equal to a film thickness of the electrode layer with a through-hole formed thereon.

According to at least one illustrative embodiment of the present invention, it may be possible to provide an electrochromic device capable of being fabricated without a bonding process and a manufacturing method thereof.

Although the illustrative embodiments and specific examples of the present invention have been described with reference to the accompanying drawings, the present invention is not limited to any of the illustrative embodiments and specific examples, and the illustrative embodiments and specific examples may be altered, modified, or combined without departing from the scope of the present invention.

The present application claims the benefit of priority based on Japanese Patent Application No. 2012-163015 filed on Jul. 23, 2012, Japanese Patent Application No. 2012-242415 filed on Nov. 2, 2012, and Japanese Patent Application No. 2013-085526 filed on Apr. 16, 2013, the entire contents of which are herein incorporated by reference.

1. An electrochromic device that has a first electrode layer, a second electrode layer provided to oppose the first electrode layer, an electrochromic layer provided between the first electrode layer and the second electrode layer, and an electrolyte filling a predetermined region between the first electrode layer and the second electrode layer, wherein a through-hole is formed on at least one layer of the first electrode layer and the second electrode layer and wherein a supporter is provided at only either one side of an outside of the first electrode layer and an outside of the second electrode layer.

2. The electrochromic device as claimed in claim 1, wherein the through-hole is an injection hole for filling with the electrolyte or the electrolyte and an electrochromic material.

3. The electrochromic device as claimed in claim 1, wherein the supporter is provided outside a layer with a through-hole formed thereon among the first electrode layer or the second electrode layer and wherein another through-hole is formed on the supporter.

4. The electrochromic device as claimed in claim 1, wherein a diameter of the through-hole is greater than or equal to 10 nm and less than or equal to 100 μm.

5. The electrochromic device as claimed in claim 1, wherein an insulative porous layer for insulating the first electrode layer and the second electrode layer is provided between the first electrode layer and the second electrode layer and wherein the insulative porous layer includes an insulative metal oxide fine particle.

6. The electrochromic device as claimed in claim 1 wherein the supporter is an optical element.

7. (canceled)

8. (canceled)

9. (canceled)

10. (canceled)

11. An electrochromic device that has a first electrode layer, a second electrode layer provided to oppose the first electrode layer, an electrochromic layer provided to contact the first electrode layer, a degradation prevention layer provided to contact the second electrode layer to prevent degradation of the second electrode layer, and an electrolyte filling between the first electrode layer and the second electrode layer and provided to contact the electrochromic layer and the degradation prevention layer, wherein each of the first electrode layer and the second electrode layer is provided with inner faces being mutually opposing faces and outer faces being faces at opposite sides of the inner faces, wherein a through-hole is formed on at least one electrode layer of the first electrode layer and the second electrode layer, wherein the electrochromic layer or the degradation prevention layer provided on the electrode layer with the through-hole formed thereon is provided on the outer face of the electrode layer with the through-hole formed thereon, and wherein a supporter is provided at only a side of the outer face of either one of the first electrode layer and the second electrode layer.

12. The electrochromic device as claimed in claim 11, wherein the electrochromic layer or the degradation prevention layer on the electrode layer with the through-hole formed thereon is also provided on the inner face of the electrode layer with the through-hole formed thereon.

13. The electrochromic device as claimed in claim 11, wherein the through-hole is an injection hole for filling with the electrolyte or the electrolyte and the electrochromic material.

14. The electrochromic device as claimed in claim 11, wherein the supporter is provided at only a side of the outer face of the electrode layer with the through-hole formed thereon and wherein another through-hole is formed on the supporter.

15. The electrochromic device as claimed in claim 11, wherein a diameter of the through-hole is greater than or equal to 10 nm and less than or equal to 100 μm.

16. The electrochromic device as claimed in claim 11, wherein an insulative porous layer for insulating the first electrode layer and the second electrode layer is provided between the first electrode layer and the second electrode layer and wherein the insulative porous layer includes an insulative metal oxide fine particle.

17. The electrochromic device as claimed in claim 11, wherein the degradation prevention layer includes a semiconductive metal oxide fine particle.

18. The electrochromic device as claimed in claim 11, wherein the electrochromic layer includes a material that changes from being colored to being transparent due to an oxidation reaction and the degradation prevention layer includes a transparent n-type semiconductive oxide particle.

19. The electrochromic device as claimed in claim 11, wherein the supporter is an optical element.

20. (canceled)

21. (canceled)

22. (canceled)

23. (canceled)
